(19) United States
(12) Patent Application Publication
(10) Pub. No.: US 2018/0083747 A1
(43) Pub. Date: Mar. 22, 2018

(54) FILTERING CARRIER FREQUENCY OFFSET IN MULTI-USER MULTIPLE-INPUT AND MULTIPLE-OUTPUT ENVIRONMENT

(71) Applicant: QUALCOMM Incorporated, San Diego, CA (US)

(72) Inventors: Dung Doan, San Diego, CA (US); Vinayak Chowdiah, San Diego, CA (US); Ronald Gibson, San Diego, CA (US); Balakumar Jayaraman, San Diego, CA (US); Maksim Krasnyanskiy, San Diego, CA (US); Bin Tian, San Diego, CA (US); Rahul Tandra, San Diego, CA (US); Luiza Timariu, San Diego, CA (US); Harshit Joshi, San Diego, CA (US)

(21) Appl. No.: 15/270,242

(22) Filed: Sep. 20, 2016

(51) Int. Cl. H04L 5/00; H04L 29/06; H04L 12/26

(52) U.S. Cl. CPC H04L 5/0023; H04B 7/0452; H04L 43/028; H04L 69/22

(57) ABSTRACT

Methods, systems, and devices for wireless communication are described including determining one or more unfiltered CFOs, filtering the one or more unfiltered CFOs to identify a refined CFO based at least in part on the one or more unfiltered CFOs and a predetermined number of packets, modifying a transmission parameter based at least in part on the refined CFO, and transmitting a signal in a MU-MIMO environment based at least in part on the modified transmission parameter.

### BACKGROUND

The following relates generally to wireless communication in a multi-user multiple-input and multiple-output (MU-MIMO) environment, and more specifically to filtering carrier frequency offset in a multiple-input and multiple-output (MIMO) environment.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a Wi-Fi network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

In multi-user communications, multiple sources of impairment may exist due to carrier frequency offset (CFO) from inaccurate determinations relating to CFO or CFO drift over time. These inaccurate or less-accurate CFO determinations and related operations among users may destroy orthogonality and degrade performance. For multi-user implementations, the CFO operating parameters may be even more stringent than single-user implementations and the problems resulting from the CFO determinations may be even more severe.

### SUMMARY

A device such as an AP communicating with multiple devices using MU-MIMO operations may transmit one or more transmissions to one or more other devices, such as a user equipment (UE). A device receiving these transmissions may determine one or more unfiltered CFOs, which may be an estimation of an actual CFO. After determining the one or more unfiltered CFOs, the UE may correct or adjust a determination about the CFO for one or more transmissions using filtering. This filtering may include filtering one CFO or multiple CFOs to determine a more-accurate, refined CFO that is closer to the actual CFO between the transmissions related to the devices. In some cases, the transmissions may include DL transmissions.

Alternatively, a device such as a UE communicating with multiple devices using multi-user multiple-input, multiple-output (MU-MIMO) operation may transmit one or more transmissions to one or more other devices, such as an access point or another UE. A device receiving these transmissions may determine one or more unfiltered CFOs, which may be an estimation of an actual CFO. After determining the one or more unfiltered CFOs, the AP or other receiving device may correct or adjust a determination about the CFO for one or more transmissions using filtering. This filtering may include filtering one CFO or multiple CFOs to determine a more-accurate, refined CFO that is closer to the actual CFO between the transmissions related to the devices. In some cases, the transmissions may include UL transmissions.

In some cases, the filtering may include one or more techniques, and different techniques or operations may be used at different states. As one example, this filtering may include using an average of at least some of the received CFOs. In addition, filtering may include using progressively filtered results (e.g., groups of unfiltered CFOs, groups of unfiltered CFOs and at least one refined CFO), where a later CFO filter operation may be dependent on an earlier CFO filter operation, refined CFO, unfiltered CFO, or some combination.

An apparatus for wireless communication in a MU-MIMO environment is described. The apparatus may include a processor, memory in electronic communication with the processor, and instructions stored in the memory. The instructions may be operable to cause the processor to determine one or more unfiltered CFOs, filter the one or more unfiltered CFOs to identify a refined CFO based at least in part on the one or more unfiltered CFOs and a predetermined number of packets, modify a transmission parameter based at least in part on the refined CFO, and transmit a signal in a MU-MIMO environment based at least in part on the modified transmission parameter.

A method of wireless communication in a MU-MIMO environment is described. The method may include determining one or more unfiltered CFOs, filtering the one or more unfiltered CFOs to identify a refined CFO based at least in part on the one or more unfiltered CFOs and a predetermined number of packets, modifying a transmission parameter based at least in part on the refined CFO, and transmitting a signal in a MU-MIMO environment based at least in part on the modified transmission parameter.

An apparatus for wireless communication in a MU-MIMO environment is described. The apparatus may include a CFO component for determining one or more unfiltered CFOs, a CFO filter component for filtering the one or more unfiltered CFOs to identify a refined CFO based at least in part on the one or more unfiltered CFOs and a predetermined number of packets, a modification component for modifying a transmission parameter based at least in part on the refined CFO, and a transmitter component for transmitting a signal in a MU-MIMO environment based at least in part on the modified transmission parameter.

Another apparatus for wireless communication in a MU-MIMO environment is described. The apparatus may include means for determining one or more unfiltered CFOs, means for filtering the one or more unfiltered CFOs to identify a refined CFO based at least in part on the one or more unfiltered CFOs and a predetermined number of packets, means for modifying a transmission parameter based at least in part on the refined CFO, and means for transmitting a signal in a MU-MIMO environment based at least in part on the modified transmission parameter.

A non-transitory computer readable medium for wireless communication in a MU-MIMO environment is described. The non-transitory computer-readable medium may include instructions operable to cause a processor to determine one or more unfiltered CFOs, filter the one or more unfiltered CFOs to identify a refined CFO based at least in part on the one or more unfiltered CFOs and a predetermined number of packets, modify a transmission parameter based at least in part on the refined CFO; and transmit a signal in a MU-MIMO environment based at least in part on the modified transmission parameter.

Some examples of the method, apparatus, or non-transitory computer-readable medium described above may further include processes, features, means, or instructions for comparing an unfiltered CFO with the refined CFO. Some examples of the method, apparatus, or non-transitory computer-readable medium described above may further include processes, features, means, or instructions for setting the refined CFO based at least in part on the comparison.

Some examples of the method, apparatus, or non-transitory computer-readable medium described above may further include processes, features, means, or instructions for determining whether to modify a transmission parameter based at least in part on comparing the refined CFO and an oscillator adjustment value.

Some examples of the method, apparatus, or non-transitory computer-readable medium described above may further include processes, features, means, or instructions for precorrecting a transmission timing, or a transmission frequency, or a combination thereof based at least in part on the refined CFO, wherein transmitting the signal in the MU-MIMO environment is based at least in part on the precorrection.

Some examples of the method, apparatus, or non-transitory computer-readable medium described above may further include processes, features, means, or instructions for comparing an unfiltered CFO with the refined CFO. Some examples of the method, apparatus, or non-transitory computer-readable medium described above may further include processes, features, means, or instructions for disregarding the unfiltered CFO based at least in part on the comparison. Some examples of the method, apparatus, or non-transitory computer-readable medium described above may further include processes, features, means, or instructions for comparing the refined CFO relative to a threshold adjustment value, wherein the modified transmission parameter is based at least in part on the comparison, and wherein the transmission parameter comprises a transmission frequency.

Some examples of the method, apparatus, or non-transitory computer-readable medium described above may further include processes, features, means, or instructions for determining a drift value associated with a clock source. Some examples of the method, apparatus, or non-transitory computer-readable medium described above may further include processes, features, means, or instructions for determining whether to adjust the refined CFO based at least in part on the determined drift value and an elapsed time, wherein the modified transmission parameter is based at least in part on determining whether to adjust the refined CFO.

Some examples of the method, apparatus, or non-transitory computer-readable medium described above may further include processes, features, means, or instructions for comparing an unfiltered CFO with the refined CFO. Some examples of the method, apparatus, or non-transitory computer-readable medium described above may further include processes, features, means, or instructions for adjusting the unfiltered CFO based at least in part on the comparison. Some examples of the method, apparatus, or non-transitory computer-readable medium described above may further include processes, features, means, or instructions for updating the refined CFO based at least in part on the adjusted unfiltered CFO.

Some examples of the method, apparatus, or non-transitory computer-readable medium described above may further include processes, features, means, or instructions for determining predetermined number of packets based at least in part on a clock source, wherein determining the refined CFO is based at least in part on the determined predetermined number of packets. Some examples of the method, apparatus, or non-transitory computer-readable medium described above may further include processes, features, means, or instructions for determining whether a received transmission from the device is intended for a station or an access point, wherein determining one or more unfiltered CFOs is based at least in part on determining whether the received transmission from the device is intended for the station or the access point.

Some examples of the method, apparatus, or non-transitory computer-readable medium described above may further include processes, features, means, or instructions for comparing an elapsed time between two received transmissions, wherein determining the refined CFO by filtering is based at least in part on a packet received after the elapsed time.

Some examples of the method, apparatus, or non-transitory computer-readable medium described above may further include processes, features, means, or instructions for identifying a number of received transmissions from the device. Some examples of the method, apparatus, or non-transitory computer-readable medium described above may further include processes, features, means, or instructions for comparing the number of received transmissions to a packet threshold value, wherein the filtering is performed on a number of packets based at least in part on the comparison.

In some examples of the method, apparatus, or non-transitory computer-readable medium described above, the filtering comprises: using a moving average. Some examples of the method, apparatus, or non-transitory computer-readable medium described above may further include processes, features, means, or instructions for determining one or more additional unfiltered CFOs. Some examples of the method, apparatus, or non-transitory computer-readable medium described above may further include processes, features, means, or instructions for filtering the one or more additional unfiltered CFOs to identify a second refined CFO. Some examples of the method, apparatus, or non-transitory computer-readable medium described above may further include processes, features, means, or instructions for comparing the refined CFO and the second refined CFO, wherein the modified transmission parameter is based at least in part on the comparison.

In some examples of the method, apparatus, or non-transitory computer-readable medium described above, filtering the unfiltered CFO to identify the refined CFO of the packet set comprises: filter the one or more unfiltered CFOs at a first time. Some examples of the method, apparatus, or non-transitory computer-readable medium described above may further include processes, features, means, or instructions for receiving a transmission after the first time. Some examples of the method, apparatus, or non-transitory computer-readable medium described above may further include processes, features, means, or instructions for filtering a subset of the one or more unfiltered CFOs based at least in part on the received another transmission.

Some examples of the method, apparatus, or non-transitory computer-readable medium described above may further include processes, features, means, or instructions for determining that a first modification of the transmission parameter based on the refined CFO occurred at a first time. Some examples of the method, apparatus, or non-transitory computer-readable medium described above may further include processes, features, means, or instructions for comparing a number of received packets since the first time to a packet counter. Some examples of the method, apparatus, or non-transitory computer-readable medium described above may further include processes, features, means, or instructions for modifying the transmission parameter at a second time using a second refined CFO based at least in part on the comparison.

### BRIEF DESCRIPTION OF THE DRAWINGS

FIG. 1 illustrates an example of a system for wireless communication that supports filtering CFO in a MIMO environment in accordance with aspects of the present disclosure.

FIG. 2 illustrates an example of a wireless communications system that supports filtering CFO in a MIMO environment in accordance with aspects of the present disclosure.

FIG. 3 illustrates an example of a state flow that supports filtering CFO in a MIMO environment in accordance with aspects of the present disclosure.

FIG. 4 illustrates an example of a process flow that supports filtering CFO in a MIMO environment in accordance with aspects of the present disclosure.

FIGS. 5A, 5B, and 6 show block diagrams of a device that supports filtering CFO in a MIMO environment in accordance with aspects of the present disclosure.

FIG. 7 illustrates a block diagram of a system including a device that supports filtering CFO in a MIMO environment in accordance with aspects of the present disclosure.

FIGS. 8 through 11 illustrate methods for filtering CFO in a MIMO environment in accordance with aspects of the present disclosure.

### DETAILED DESCRIPTION

In wireless systems, during some wireless communications high CFO variations have been observed, which may lead to degraded system performance. To be effective, CFO correction schemes should account for inherent CFO determination or estimation error as compared to an actual CFO, and error associated with a crystal or an oscillator based on hardware and other limitations. The present disclosure describes methods and techniques for filtering CFOs to obtain one or more refined CFOs. In some cases, this filtering may occur before oscillator (e.g., voltage controlled crystal oscillator (VCXO)) adjustments. The use of the present methods and techniques may enable communications in a MU-MIMO environment, including transmissions in a MU-MIMO context.

In some cases, the filtering may be performed at a UE based on received DL transmissions from one or more APs. In other cases, the filtering may be performed at an AP based on received UL transmissions from one or more UEs. Based on this filtering, data may be modified by adjusting UL or DL transmission parameters from a refined CFO value, and data may be transmitted to one or more other devices. In some cases, the device performing at least some of these operations—including the filtering—may be a UE in a MU-MIMO environment. In other cases, the device performing at least some of these operations—including the filtering—may be an AP in a MU-MIMO environment.

In some cases, an unfiltered CFO may be determined based on a received transmission using one or more methods. As one example, an unfiltered CFO may be determined for each packet received at a device, which may be based on a single transmission or multiple transmissions. In some cases, an unfiltered CFO is determined from a DL transmission or an UL transmission. In some examples, the unfiltered CFO value may be determined based on at least some of the symbols contained in a preamble associated with a received transmission or a received packet (e.g., a trigger packet, another packet). This may be based on using one or more algorithms relating to the symbols associated with the received transmission, among other methods. In some examples, the unfiltered CFO may be determined based on comparing received information associated with a transmission and other information relating to previous and/or subsequent transmissions or related data.

In multi-user communications, multiple sources of impairment may exist due CFO from inaccurate determinations. In the context of multiple users, such as MU-MIMO implementations, inaccurate CFO determinations and related operations among users may destroy orthogonality and degrade performance for the spatial streams. For multi-user implementations, the CFO operating parameters may be even more stringent to maintain orthogonality associated with the multiple users and related transmissions because the number of spatial streams increases as the number of users increase—as is characteristic in MIMO and MU-MIMO environments. The MU-MIMO environment, among others, presents distinct challenges because the CFO among users related to a device (e.g., an AP) should not exceed a few hundred Hz to maintain orthogonality. Thus, in MU-MIMO applications, inaccurate CFO determinations and operations are magnified due to the more-complex organization, increased number of transmissions, and the associated constraints related to maintaining orthogonality. The problems resulting from inaccurate CFO determinations and operations may be even more severe in the multiple-user context. In addition, for UL MU-MIMO orthogonal frequency-division multiplexing (OFDM) transmissions or operations, devices (e.g., STAs) may precorrect their timing and frequency so that a signal received at another device (e.g., an AP) is aligned in time and frequency to some degree in order to maintain orthogonality. The time and frequency alignment requirement is especially stringent for high order of modulation and when the number of spatial streams is large (e.g., MU-MIMO environment). In some methods, a device (e.g., a STA) may first estimate an unfiltered CFO from a DL trigger packet, but these CFO estimates usually may not meet the time and frequency alignment requirement even when the channel condition is good (i.e., a high SNR).

As described in the present disclosure, one or more unfiltered CFOs may be filtered to obtain a refined CFO before frequency and time precorrected, which may be based on one or more refined CFOs. In some examples, by filtering and refining the unfiltered CFO estimates, precorrecting time and/or frequency (among other things), and then transmitting more accurate signals based on one or more modified transmission parameters, a simplified receiver can be used (i.e., by avoiding complicated phase tracking during channel training and/or other operations requiring additional hardware or functionality).

Aspects of the disclosure are initially described in the context of a wireless communication system. Specific examples are then described for multi-user communication examples, multi-state operations for CFO filtering and correction, and examples of process flows relating to CFO filtering and correction. Aspects of the disclosure are further illustrated by and described with reference to apparatus diagrams, system diagrams, and flowcharts that relate to title of the application.

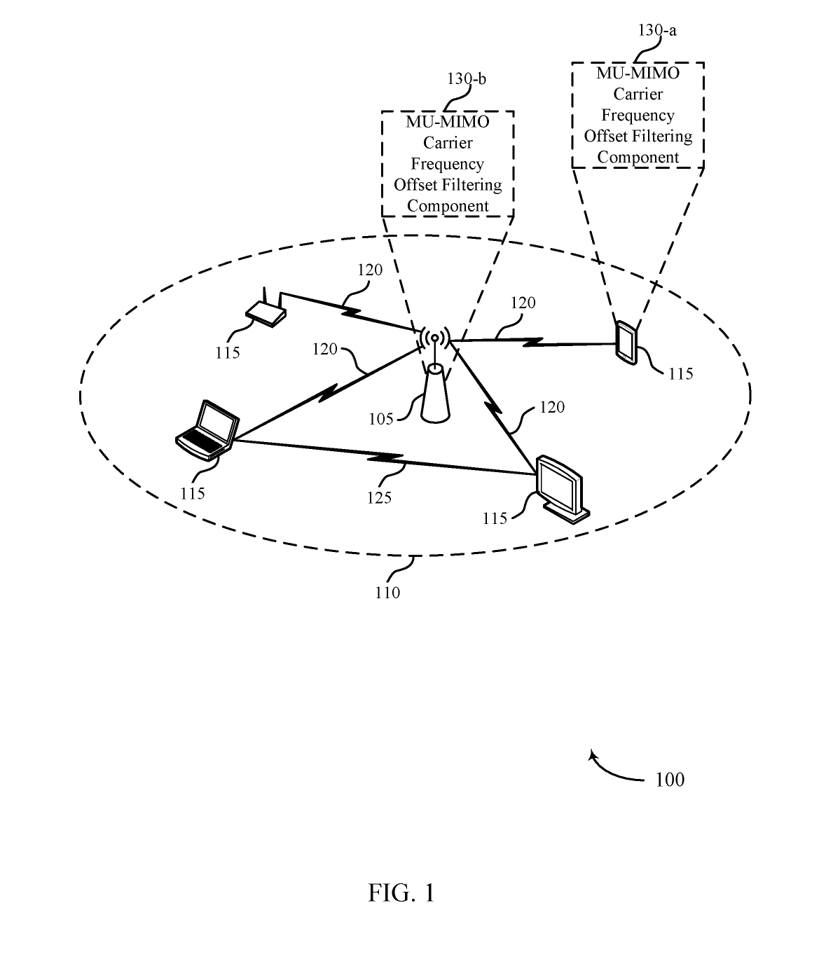

FIG. 1 illustrates a wireless local area network (WLAN) 100 (also known as a Wi-Fi network) configured in accordance with various aspects of the present disclosure. The WLAN 100 serves as merely one example of a wireless communications network, which may include an AP 105 and associated STAs 115. In some examples, STAs 115 may represent devices such as mobile stations, personal digital assistant (PDAs), other handheld devices, netbooks, notebook computers, tablet computers, laptops, display devices (e.g., TVs, computer monitors), printers, etc. The AP 105 and the associated STAs 115 may represent a basic service set (BSS) or an extended service set (ESS). In some examples, the AP 105 may represent a base station. The various STAs 115 in the network are able to communicate with one another through the AP 105. Also shown is a coverage area 110 of the AP 105, which may represent a BSA of the WLAN 100. An extended network station (not shown) associated with the WLAN 100 may be connected to a wired or wireless distribution system that may allow APs 105 to be connected in an ESS. In some examples, one or more of the STAs 115 may include a MU-MIMO CFO filtering component 130-a, which may enable the STAs 115 to filter and correct CFOs associated with MU-MIMO DL transmissions, modify UL transmission parameters based at least in part on the filtered CFOs, and transmit UL data in an UL MU-MIMO environment based on the modified UL data. In some examples, the AP 105 may include a MU-MIMO CFO filtering component 130-b, which may enable the AP 105 to filter and correct CFOs associated with MU-MIMO UL transmissions, modify DL transmission parameters based at least in part on the filtered CFOs, and transmit DL data in a DL MU-MIMO environment based on the modified DL data.

Although not shown in FIG. 1, a STA 115 may be located in the intersection of more than one coverage area 110 and may associate with more than one AP 105. An AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network), with varying and overlapping coverage areas 110. Two STAs 115 may also communicate directly via a direct wireless link 125 regardless of whether both STAs 115 are in the same coverage area 110. An STA 115 may also communicate directly with an AP 105 via a direct wireless link 120. Examples of direct wireless link 120 and direct wireless link 125 may include Wi-Fi Direct connections, Wi-Fi Tunneled Direct Link Setup (TDLS) links, and other group connections. STAs 115 and APs 105 may communicate according to the WLAN radio and baseband protocol for physical and medium access control (MAC) layers. In other implementations, peer-to-peer connections or ad hoc networks may be implemented within WLAN 100.

In some cases, a STA 115 (or an AP 105) may be detectable by an AP 105 (e.g., a central AP), but not by other STAs 115 (or APs 105) in the coverage area 110 of an AP 105 (e.g., a central AP). For example, one STA 115 may be at one end of the coverage area 110 of the AP 105 (e.g., central AP) while another STA 115 may be at the other end. Thus, both STAs 115 may communicate with the AP 105, but may not receive the transmissions of the other. This may result in colliding transmissions for the two STAs 115 in a contention based environment (e.g., carrier sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

A STA 115 or an AP 105 may be configured to collaboratively communicate with multiple devices through, for example, MIMO communication. MIMO techniques use multiple antennas on the APs 105 or multiple antennas on the STA 115 to take advantage of multipath environments to transmit multiple data streams.

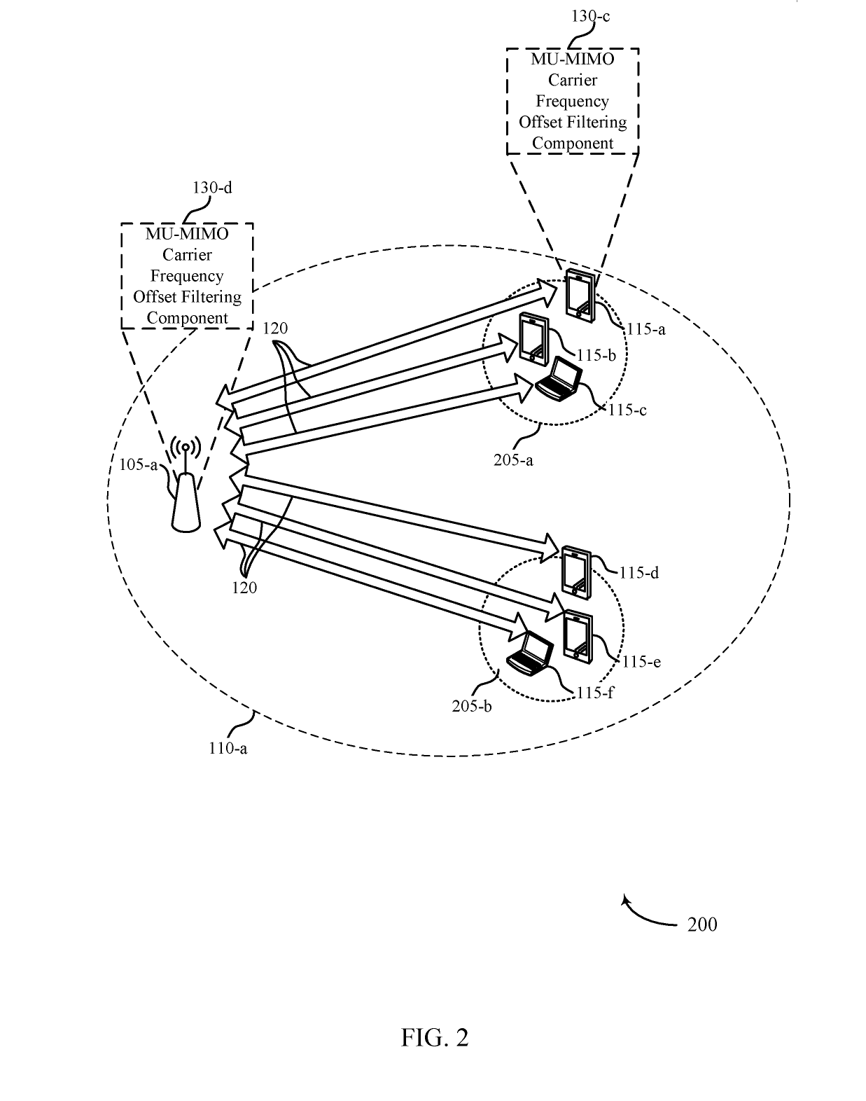

FIG. 2 illustrates an example of a wireless communications system 200 MU-MIMO communication based on CFO filtering and correction. Wireless communications system 200 may include AP 105-a and STA 115-a, 115-b, 115-c, 115-d, 115-e and 115-f, which may communicate over a direct wireless link 120, and may be examples of the corresponding devices described with reference to FIG. 1.

Wireless communications system 200 may support multi-user configurations based on transmitting and receiving with multiple antennas. For example, wireless communications system 200 may utilize MIMO technology to increase packet throughput and enable additional, more-effective UL and DL communications.

In other examples, one or more STAs (e.g., STA 115-a) may receive DL transmissions from AP 105-a. Based on these transmission, STA 115-a, as one example, may perform operations to evaluate and determine one or more unfiltered CFOs relating to the transmission from AP 105-a, among other sources. These operations may include precorrecting timing and frequency so that AP 105-a receives an UL signal that is aligned in time and frequency to help maintain orthogonality. In some cases, the time and frequency alignment characteristics may be more stringent for higher order modulation and as the number of spatial streams increases—as is characteristic in MIMO and MU-MIMO environments. Thus, in MU-MIMO applications, inaccurate CFO operations and estimates are magnified due to the more-complex organization and increased number of transmissions.

In some cases of MU-MIMO functions, the CFO variation among STAs relative to AP 105-a should not exceed a predetermined threshold (e.g., a couple hundred Hz). Unfiltered determinations or estimates of CFOs may not meet the alignment parameters. As described in the present disclosure, unfiltered CFOs may be filtered to obtain a refined CFO. In some cases, this may occur before other correction, such as frequency and time correction. In some cases, through refining the CFO determinations or estimates and correcting CFO-related parameters (e.g., time, frequency) at a first device (e.g., a STA 115, an AP 105), a simplified second device (e.g., an AP 105-a, STA 115) and associated receiving operations may be realized, including avoiding phase tracking during channel training of the devices and other benefits. In some examples, an unfiltered CFO may include a determined CFO that represents an initial CFO that pertains to one or more UL or a DL transmissions.

In some examples, one or more STAs served by AP 105-a within coverage area 110 may engage in CFO determination (e.g., estimation) and filtering operations. In some cases, each STA (e.g., STA 115-a, 115-b, 115-c, 115-d, 115-e and 115-f) may engage in CFO determination and filtering operations to enable more accurate UL communications with AP 105-a. In some examples, one or more APs 105-a in communication with a STA 115-a 5-a within coverage area 110 may engage in CFO determination and filtering operations. In some cases, each AP (AP 105-a) may engage in CFO determination and filtering operations to enable more accurate DL communications with STA 115-a. In some examples, one or more of the STAs 115 (e.g., STA 115-b) may include a MU-MIMO CFO filtering component 130-c, which may enable the STAs 115 to filter and correct CFOs associated with MU-MIMO DL transmissions, modify UL transmission parameters based at least in part on the filtered CFOs, and transmit modified UL data in an UL MU-MIMO environment.

Additionally or alternatively, one or more of the STAs 115 may transmit data in an UL MU-MIMO environment based at least in part on the modified UL data, which may or may not include transmitting the modified UL data. In some examples, the AP 105-a may include a MU-MIMO CFO filtering component 130-d, which may enable the AP 105-a to filter and correct CFOs associated with MU-MIMO UL transmissions, modify DL transmission parameters based at least in part on the filtered CFOs, and transmit modified DL data in a DL MU-MIMO environment. Additionally or alternatively, one or more of the STAs 115 may transmit data in a DL MU-MIMO environment based at least in part on the modified data, which may or may not include transmitting the modified DL data.

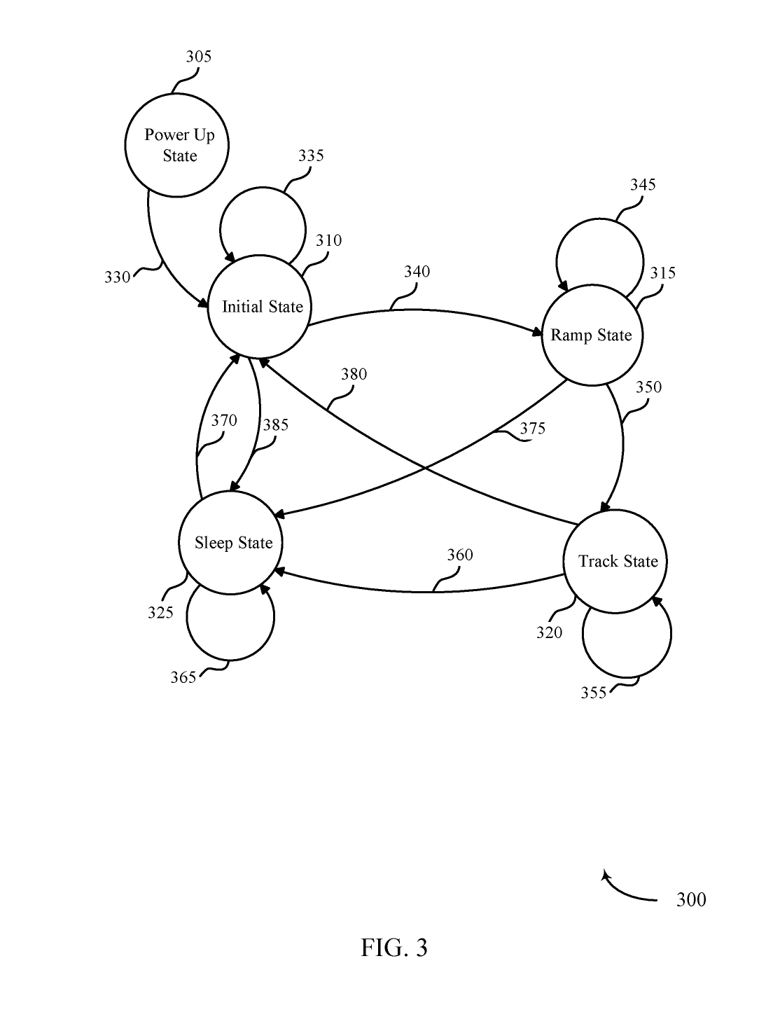

FIG. 3 shows a block diagram of a wireless device 300 for filtering CFO in a MIMO environment. In some cases, wireless device 300 may represent aspects of techniques performed by a STA 115 or AP 105 as described with reference to FIG. 1. Wireless device 300 may include various components enabling CFO filtering, CFO correction, and other operations. For example, wireless device 300 may include a receiver, a MU-MIMO CFO filtering component, or a transmitter. Wireless device 300 may also include a processor. Each of these components may be in communication with each other directly or indirectly.

FIG. 3 describes various actions and states that may be performed for MU-MIMO communication based on CFO filtering and correction. For example, as part of a power up state 305, one or more operations may be performed. In some cases, these operations may include a reset state that resets one or more components to a specified value or state. In some cases, this may include a test trigger state that enables a device to determine a characteristic or status relating to the state.

After the power up state 305, wireless device 300 may be activated via transition 330 to begin an initial state 310. Transition 330 may occur automatically or may be based on one or more parameters, signals, or actions performed in power up state 305. As a result, transition 330 (or transition 370, discussed more below) may be triggered based on one or more operations that may occur as part of initial state 310. For example, one or more buffer data elements may be cleared as before or as part of transition 330 before initiating other initial state 310 operations. In some cases, at least some buffer data may be cleared. This may include clearing a subset of the buffer data that relates to older items or operations that occurred before a predetermined time.

Initial state 310 may allow for CFO precorrection with or without filtering based on a predetermined number of packets. In some case, the predetermined number of packets may be based on packets having a characteristic. As one example, this characteristic may include being intended for a certain device (e.g., wireless device 300), among others. In some examples, CFO precorrection and/or filtering may be applied to a number of packets or individual packets on a per-packet basis. In some cases, CFO precorrection may be performed after a packet having an unfiltered CFO is received without performing filtering on the packet. Or, in some cases, a CFO precorrection may be performed after a packet having an unfiltered CFO is received along with performing filtering. In other cases, CFO correction may be performed after a predetermined period from when a packet having an unfiltered CFO is received. This CFO precorrection may, in some cases, include adjusting individual unfiltered CFOs on a per-packet basis for a number of packets.

In some examples, CFO correction is performed individually for a number of packets that are received, until an unfiltered state threshold is reached or satisfied. As one example, an unfiltered state threshold value may be 3, 5, or 10 packets. This example merely describes one case and other examples are specifically contemplated and fall within the scope of this disclosure. In some cases, an unfiltered state threshold may be less than a ramp state threshold, which is discussed below. In some cases, an unfiltered state threshold may be based on a relationship with a ramp state threshold, another threshold, or other information.

In some cases, one or more corrections are performed on one or more individual packets during initial state 310. For example, an unfiltered CFO corresponding to one or more packets may be determined by wireless device 300. In some cases, this unfiltered CFO may include a raw, initial CFO associated with one or more received transmissions (e.g., DL transmissions, UL transmission). In some cases, the unfiltered CFO may be corrected based on a crystal adjustment. For example, a crystal (e.g., a VCXO) may be associated with one or more drift errors affecting CFOs over time. By detecting this drift error using one or more methods, such as calibration or other operations, a CFO may be adjusted to compensate for a determined drift error. In some cases, a determined drift error may be based on a measured drift error for a period, a calculated average drift error, or another value or parameter.

In some examples, CFO correction may not be performed on the unfiltered CFO. In some cases, this may be based on a determined drift error value or threshold. In some cases, this may be based on comparing a drift error amount with the unfiltered CFO, such as evaluating the amount of drift error compared to the unfiltered CFO. Based on the relationship between these values, correction may or may not be applied. For example, if drift error falls below a threshold for one or more packets during the unfiltered state, no correction or adjustment of the unfiltered CFO may be performed. Among other reasons, this may be based on the number of packets that may be processed during the initial state 310, the length of time that wireless device 300 may execute initial state 310, or other parameters.

In some cases, after one or more operations that may or may not include CFO correction in the initial state 310, the number of corrections or packets referenced or received may be compared to the unfiltered state threshold, as depicted by action 335. In some examples, CFO correction is performed individually for a number of packets that are received, until an unfiltered state threshold has been reached.

In some cases, after an unfiltered state threshold has been reached during initial state 310, wireless device 300 may transition (via transition 340) to begin ramp state 315 based on reaching the unfiltered state threshold. This transition 340 may occur automatically or may be based on one or more parameters, signals, or actions performed in power up state 305 or initial state 310.

Ramp state 315 may allow for CFO filtering and correction based on a predetermined number of packets. In one example, CFO filtering and correction may be applied to a number of packets. In some cases, the CFO filtering and correction may be applied to all the packets received during an evaluation period. In other cases, the CFO filtering and correction may be applied to a subset of the packets received during an evaluation period.

In some cases, CFO correction may be performed after a packet having an unfiltered CFO is received. In other cases, CFO correction may be performed after a predetermined period from when a packet having an unfiltered CFO is received.

In some examples, CFO correction is performed for a number of packets that are received including or separate from one or more packets received during initial state 310, until an ramp state threshold. As one example, a ramp state threshold may include 19, 29, 39, or 49 packets—among others. This example merely describes one case and other examples are specifically contemplated and fall within the scope of this disclosure. In some cases, a ramp state threshold may be greater than an initial state threshold value. In some cases, a ramp state threshold may be based on a relationship with an initial state threshold, a track state threshold, another threshold, or other information.

In some cases, ramp state operations may be performed on each packet in a group of packets received, until the number in the group exceeds the ramp state threshold. For example, the operations performed may include applying CFO filtering and correction for a group of 10 packets. Then, after receiving an additional packet (or multiple additional packets), the CFO filtering and correction may be applied to the 11 packets. This process may continue to occur until the ramp state threshold is reached (e.g., until a ramp count is not less than the ramp state threshold), as signaled by action 345. This example merely describes one case and other examples are specifically contemplated and fall within the scope of this disclosure.

Examples of ramp state operations are described here, although variations and modifications are specifically contemplated. In some cases, some or all of these operations may be performed on one data packet at time. In other cases, some or all of the operations may be performed on multiple data packets at a time.

One ramp state operation may include determining whether a received packet related to a received transmission (e.g., a DL transmission, an UL transmission) is intended for one or more devices (e.g., STAs, APs). For example, wireless device 300 (e.g., a STA) may determine if a received packet with associated CFO information is intended for itself or for another device based on determining identification-related information related to a received transmission, such as information included in a packet or otherwise. If the received packet (or a group of evaluated packets) is intended for wireless device 300, then CFO filtering and correction may be performed. If the received packet (or a group of evaluated packets) is not intended for wireless device 300 then CFO filtering and correction may be performed on other packets, and the packet intended or meant for another device may be disregarded or discarded.

Another ramp state operation may include determining an unfiltered CFO of a packet set based on one or more received transmissions. In some cases, this determination or estimation of one or more unfiltered CFOs may be based on a raw measurement or an estimation of CFOs. In some cases, this determination may include estimating unfiltered CFOs of one or more packets in a packet set. This packet set may include packets received during a predetermined time, an elapsed time, relating to one or more related specified transmissions, or a subset of packets received during a period.

In addition, a ramp state operation may include performing a CFO filtering operation. This filtering may be designed to filter or refine the unfiltered CFO or CFOs to identify a refined CFO related to one or more packets, which may include identifying a refined CFO related to the packet set.

Various operations, methods, and techniques may be used to filter or refine the unfiltered CFOs, and those described here are merely exemplary, and other operations, methods, and techniques are specifically contemplated. As one example, a filtering operation may be performed. This filtering operation may, in some cases, be based on using a moving average by determining a refined CFO that corresponds an average value of determined, unfiltered CFOs.

In some cases, the CFO filtering may be performed on one or more packets received during one or more states. For example, the CFO filtering may be performed on at least some or each packet received during the ramp state based on the determined unfiltered CFO related to each packet. Alternatively, the CFO filtering may be performed on at least some or each packet received during the initial state and the ramp state.

The CFO filtering may include evaluating the unfiltered CFOs (e.g., a measured raw CFO, a determined or estimated CFO) of one or more packets with a predetermined number of packets (e.g., a window length). As described in the present disclosure, a window length may be one example of a predetermined number of packets. In some examples, the predetermined number of packets may include a number of packets may correlate with the number of unfiltered CFOs. For example, 40 unfiltered, determined CFOs may be determined, summed, and evaluated relative to a predetermined number (i.e., 40) such that the unfiltered determined CFOs may be evaluated with reference to a number (which may correspond to the number of CFOs or packets). In some cases, this window length may be or relate to a ramp state threshold. In other cases, this predetermined number of packets (e.g., a window length) may be or relate to the number of received packets that are being compared. For example, if 10 packets have been received and form a packet set, the unfiltered CFOs of these packets may be compared along with a predetermined number of packets (e.g., a window length) of 10. This example merely describes one case and other examples are specifically contemplated and fall within the scope of this disclosure. As one example, the CFO filtering may be based on operations relating to a formula or an algorithm. For example, the ramp state filtering to determine a refined CFO may be based on:

Refined CFO(k)=(1/window length)*(unfiltered CFOs)

Here, the refined CFO for the k-th packet may be based on a comparison of the sum of one or more unfiltered CFOs for packets received (e.g., from the first packet k=0 up to the k−1 packet) that comprise the packet set with the window length (e.g., the number of the packets having the CFOs summed).

Further, as additional packets are received this process may repeat, including determining the refined CFO (k+1), incrementing the predetermined number of packets (e.g., a window length), and comparing an additional CFO (from the k-th packet). In some variations, the refined CFO for the k+1 packet may be based on evaluating various unfiltered CFOs. In some cases, the CFOs may only include raw CFOs determined or estimated directly from the received DL or UL transmissions. In other cases, however, the CFOs may include refined CFOs for at least some of the previous packets up to the k-th packet (using the above formula or another method). In other cases, the CFOs may include some refined CFOs and some raw CFOs determined or estimated directly from the received DL transmissions.

Other operations may include various methods, operations, and techniques. As further examples, other techniques may be based on one or more filtering methods or combinations of such methods. These may include using a finite impulse response (FIR) filter, an infinite impulse response (IIR), a weighted filter enabling weighting of one or more values (e.g., one or more CFOs), such as a number of the most recently received and/or determined CFOs or those based on information received within a predetermined period—based on various criteria, or other filtering techniques.

These determinations and related operations may be performed on a packet-by-packet basis, a group of received packets, a subset of received packets during a period, or based on another division of packets or data.

Another ramp state operation may include comparing a refined CFO for a packet to an oscillator threshold value. This comparison may, in some cases, allow for selective adjustment or selective modification of UL or DL data related to a crystal (e.g., an oscillator) based on certain circumstances or constraints, while also limiting noise and over-correction stemming from constant adjustment. This avoids the disadvantages of constant updating that may occur for calibration or other functions. In some cases, this oscillator threshold value may be related to an estimated or determined clock source drift rate associated with wireless device 300 and/or other devices. For example, a measured clock source drift rate may be about 2.25 Hz, and the oscillator threshold value may be related to this drift rate as a multiple, a factor, by some other relationship. Here, the oscillator threshold value may be set at 25 Hz, which is approximately ten times the clock source drift rate. Thus, in this operation, the refined CFO may be compared to the oscillator threshold value. This example merely describes one case and other examples are specifically contemplated and fall within the scope of this disclosure.

Another ramp state operation may include adjusting a clock source (e.g., a crystal, a VCXO) based on comparing a refined CFO for a packet to an oscillator threshold value. If it is determined that the refined CFO for a packet is greater than or equal to the oscillator threshold value then this refined CFO may be applied to the clock source, and by extension this may be included with an UL or a DL transmission packet or data. In this case, the UL or DL data may be based on the refined CFO.

Alternatively, if it is determined that the refined CFO for a packet is less than (or in some cases less than or equal to) clock source threshold then this refined CFO may not be applied. Instead, in some cases, this refined CFO may be stored for further operations relating to other packets. In other cases, this refined CFO may be disregarded or discarded.

As another alternative, if the refined CFO is less than a clock source threshold, then either the refined CFO may be stored or a refined CFO for a previous packet may instead be stored and used for further operations relating to other packets. If the later refined CFO does not vary by more than a threshold amount when compared to an earlier refined CFO, it may be determined that the earlier refined CFO could be used and may set the later refined CFO to the earlier refined CFO.

Another ramp state operation may include incrementing a ramp counter. As depicted in action 345, one or more operations described above may be performed in a loop until a ramp counter is equal to or exceeds a ramp state threshold (i.e., rolling average window size or number of packets).

As merely one example, a flow of operational steps during a ramp state for an individual packet is described here. The present disclosure is not limited by this example. This example merely describes one case and other examples are specifically contemplated and fall within the scope of this disclosure.

A first operation may include a ramp mode process, which may include inputting or receiving a CFO determination or estimate (e.g., an unfiltered CFO) for a new packet. A second operation may include a related to checking whether a packet is intended for the STA performing the ramp operations by comparing information included in the transmission to a station identifier or name. If not, then the operations may cease. If so, the operations may continue. A third operation may include feeding the CFO determination or estimate to a moving average filter buffer.

A fourth operation may include performing a moving average filter process and outputting a filter out value. A fifth operation may include a decision about whether the absolute value of the filter out value is greater than or equal to a threshold value related to the oscillator (i.e., a VCXO threshold). If not, then the operations may cease. If so, the operations may continue. A sixth operation may include applying the filter out value to VCXO information associated with a transmission packet. A seventh operation may include incrementing a ramp counter.

In some cases, based at least in part on reaching a ramp state threshold during ramp state 315, wireless device 300 may transition (via transition 350) to begin track state 320 based on the ramp state threshold being reached. This transition 350 may occur automatically or may be based on one or more parameters, signals, or actions performed in initial state 310 or ramp state 315.

Track state 320 may allow for CFO filtering and correction based on a predetermined number of packets. In one example, CFO filtering and correction may be applied to a less than all the received number of packets. In some cases, the CFO filtering and correction may be applied to all the packets received during an evaluation period. In other cases, the CFO filtering and correction may be applied to a subset of the packets received during an evaluation period, including a subset that may be based on a track state window length corresponding to a predetermined number of packets, a number of most recently received packets or determined unfiltered CFOs related to the packets, or packets received within or unfiltered CFOs determined within a predetermined period.

In some cases, CFO filtering may be performed after a packet having an unfiltered CFO is received. In other cases, CFO correction and filtering may be performed after a predetermined period from when a packet having an unfiltered CFO is received.

In some cases, determining a track state window length may be based on evaluating operations performed during the ramp state or those performed during the track state, such as CFO correction actions. Implementations using a longer track state window length may be more accurate based on more robust calculations—including standard deviation, based on considering additional refined CFOs relating to more packets received from DL or UL transmissions. In some cases, however, a longer track state window length must be balanced with providing responsive and timely CFO refinements and adjustments.

For example, a longer track state window length will be less susceptible to changing CFOs—even refined CFOs—because of the increased number of values considered. In some cases, a system may be calibrated to determine a track state window length that will provide accurate measurements, while also facilitating nimble and timely adjustments. In other cases, a predetermined number of packets (e.g., a track state window length) may be set and used for a period. This predetermined number of packets may be updated or modified based on measurements or one or more other parameters relating to the operations described in this disclosure.

In some cases, a track state window length may be or be related to a ramp state threshold. For example, a track state window length may be one more than the ramp state threshold. Alternatively, in some cases, the track state window length may be equal to the ramp state threshold, or may otherwise be related to the ramp state threshold.

In some examples, CFO correction is performed for a number of packets that are received for a predetermined period of time or until the number of packets received during a period through DL or UL transmissions does not satisfy a predetermined threshold. In some cases, track state operations may be performed on each packet in a group of packets received until one or more conditions is met. This process may continue to occur until the one or more conditions is satisfied, as signaled by action 355. As one example, this process may continue to occur until the time between when an old packet is transmitted or received and a new packet is transmitted or received greater than or equal to a predetermined age time threshold. In some cases, merely as an example, the predetermined age time threshold may be within a predetermined range of 10,000 msec. This example merely describes one case and other examples are specifically contemplated and fall within the scope of this disclosure. In some cases, when the time between when an old packet is transmitted or received and the a new packet is transmitted or received greater than or equal to a predetermined age time threshold, the track state operations may cease based on a reset condition. In some cases, as a result, the wireless device 300 may transition to sleep state 325 (via one of transitions 360, 375, or 385) or reinitiate and transition to initial state 310 (via transition 370), respectively. This example merely describes one case and other examples are specifically contemplated and fall within the scope of this disclosure.

Examples of track state operations are described here, although variations and modifications are specifically contemplated. In some cases, some or all of these operations may be performed on one data packet at time. In other cases, some or all of the operations may be performed on multiple data packets at a time.

One track state operation may include determining whether a received packet related to a received DL transmission is intended for one or more stations. For example, wireless device 300 (e.g., a STA, an AP) may determine if a received packet with an associated CFO information is meant for or intended for itself or another device. If the received packet (or a group of evaluated packets) is intended for wireless device 300 then CFO filtering and correction may be performed. If the received packet (or a group of evaluated packets) is not intended for wireless device 300, then CFO filtering and correction may be performed on other packets, and the packet intended or meant for another device may be disregarded or discarded.

An additional track state operation may include a CFO limit check. In some cases, this limit check may determine whether an unfiltered CFO (and its corresponding error) signal an abnormality, an outlier value, or an inaccurate raw CFO. This limit check may then limit the CFO to preserve the accuracy of the CFO filtering and correction operations.

As one example, this limit check limit may include comparing a new CFO with a previously refined CFO (which may or may not be the immediately-prior refined CFO). This comparison may include determining the difference between the new CFO and the previous refined CFO and comparing this difference to a limit threshold. In some cases, the limit threshold may be related to the length of the packet interval, the determined clock source drift for the length of the packet interval, and/or the related determined CFOs. For example, based on a longer packet interval (e.g., about 750 msec) the CFO limit may be limited to a multiple of the measured clock drift rate for the this packet interval (e.g., about 22.5 Hz). As another example, based on a shorter packet interval (e.g., about 100 msec) the CFO limit may be limited to a multiple of the measured clock drift rate for the this packet interval (e.g., about 3 Hz). This example merely describes one case and other examples are specifically contemplated and fall within the scope of this disclosure.

Using a limit check limit, the track operations may limit the difference in CFOs, including the CFOs of two consecutive packets, above the limit for the respective packet interval. In some cases, this limit check may be different than other methods and techniques that completely disregard some CFOs in favor of comparing additional values. Instead, in some cases, these methods and techniques use CFOs that signal an abnormality by limiting it, but still accounting for the estimated value, which may, in some circumstances, enable more accurate and timely operations and corrections.

As one example, a CFO estimate may be truncated, limited, or capped according to an algorithm and related comparisons of values:

CFO cap value=Refined CFO(k−1)+sign(Refined CFO(k−1)−Unfiltered CFO(k))*Limit

Where the limited or truncated CFO (i.e., CFO cap value) may be based on a previously identified refined CFO. In some cases, this previously identified refined CFO may be the value previously determined for the immediately-prior packet (e.g., refined CFO for k−1 packet) that may also have been based on other packets and related CFOs, while in other cases it may not. The limited or truncated CFO value may also be based on a sign (e.g., an absolute value) of a difference between the previously identified refined CFO (e.g., refined CFO for the k−1 packet) and an unfiltered or raw estimated CFO for a later packet (e.g., unfiltered CFO for the k packet). This determined sign may be multiplied with a limit, which may be predetermined or may be based on one or more measurements or calibrations. In some examples, this limit may be based on a clock drift rate, or a packet interval, or both, among other things. In some cases, the limit (e.g., 22.5 Hz, 3 Hz, 300 Hz) may be based on or a multiple of clock rate draft for a period. This example merely describes one case and other examples are specifically contemplated and fall within the scope of this disclosure. In some cases, the limited CFO may be the adjusted CFO for a particular packet or may be used as a value from which a refined CFO may be calculated—together with or separate from one or more other unfiltered CFOs and/or refined CFOs.

As described above, if the unfiltered CFO related to a packet k is greater than the limit threshold, the unfiltered CFO may be limited or truncated. In some cases, this limited value may become the adjusted CFO for packet k, and may be based on a limited CFO added to or subtracted from the previous refined CFO(s) of one or more packets. For example, if the unfiltered CFO is greater than the previous refined CFO(s) of one or more packets, then the adjusted CFO for the packet may be the previous refined CFO plus a limit threshold, which increments the refined CFO. For example, if the unfiltered CFO is less than the previous refined CFO(s) of one or more packets, then the adjusted CFO for the packet may be the previous refined CFO minus a limit threshold, which decrements the refined CFO. In some cases, the adjusted CFO may be a determined or estimated CFO.

In some cases, if the unfiltered CFO for a packet k is less than the limit threshold, then the adjusted CFO may be set to the unfiltered CFO.

Another track state operation may include determining (e.g., estimating) an unfiltered CFO of a packet set based on one or more received DL transmissions, which may be separate from or combined with operation described in the present disclosure. In some cases, this determining of one or more unfiltered CFOs may be based on a raw measurement or an estimation of CFOs. This may be based on one or more received DL transmissions. In some cases, this determining may include estimating unfiltered CFOs of one or more packets in a packet set or multiple packet sets. A packet set may include packets received during a predetermined time, an elapsed time, relating to one or more related DL transmission, or a subset of packets received during a period.

In addition, a track state operation may include performing a CFO filtering operation. This filtering may be designed to filter or refined the unfiltered CFO or s to identify a refined CFO related to one or more packets, which may include identifying a refined CFO of the packet set. In some cases, this filtering may be based on determined or estimated CFOs, adjusted CFOs, other information, or some combination.

Various operations, methods, and techniques may be used to filter or refine the unfiltered CFOs, and those described here are merely exemplary, and other operations, methods, and techniques are specifically contemplated. As one example, a filtering operation may be performed. This filtering operation may, in some cases, be based on using an average, including, but not limited to, a moving average.

In some cases, the CFO filtering may be performed on one or more packets received during one or more states. For example, the CFO filtering may be performed on at least some or each packet received during the unfiltered state, the ramp state, or the track state. Alternatively, the CFO filtering may be performed on at least some or each packet received during the initial state, the ramp state, the track state, or some combination.

The CFO filtering may include comparing the unfiltered CFO (e.g., a measured, a determined, or an estimated CFO) of one or more packets with a window length.

In some cases, once a certain threshold number of packets have been received and evaluated in the ramp state, the track state may perform one or more operations based on a track state window length. For example, a track state window length may be a predetermined constant. In other examples, a track state window length may vary, and may be adjusted automatically, dynamically, or otherwise based on one or more parameters, including those relating to a DL or an UL transmission, packet information, filtering operations, or other information. In some cases, a track state window length may be based on a predetermined number of packets (e.g., 20, 30, 40, 50). A track state window length may relate to comparing and evaluating a predetermined number of packets and an associated number of CFOs (e.g., 40). This example merely describes one case and other examples are specifically contemplated and fall within the scope of this disclosure.

In some cases, this predetermined number of packets (e.g., window length) may relate to a ramp state threshold. For example, the track state window length may greater than, equal to, or less than the ramp state threshold. In some cases, the track state window length (e.g., 40) may be one greater than the ramp state threshold (e.g., 39). This example merely describes one case and other examples are specifically contemplated and fall within the scope of this disclosure. In other cases, this window length may be or relate to the number of received packets that are being compared. For example, if 50 packets have been received and form a packet set, the unfiltered CFOs of at least some of these packets may be compared with a window length of 40. This example merely describes one case and other examples are specifically contemplated and fall within the scope of this disclosure. In this case a subset of the total number of received packets having associated CFOs may be compared with a track state window length.

As one example, the CFO filtering may be based on operations relating to a formula or an algorithm. For example, the track state filtering to determine a refined CFO may be based on:

Refined CFO(k)=(1/window length)*(CFOs)

Here, the refined CFO for the k-th packet may be based on a comparison of the sum of one or more unfiltered CFOs for a number of packets received (e.g., based on at least some of the packets received) that comprise the packet set corresponding to the window length (e.g., the number of the packets having the CFOs summed). In some cases, the comparison of the sum of one or more unfiltered CFOs for a number of packets received may be based on a subset of the packets that have been received. As one example, the comparison of the sum of one or more unfiltered CFOs may be based on the CFOs for a number of most-recently received packets (e.g., the last 50 packets received). In some cases, the window length may be equal to the number of summed CFOs. This example merely describes one case and other examples are specifically contemplated and fall within the scope of this disclosure.

Further, as additional packets are received and this process can repeat, including determining the refined CFO (k+1) (i.e. the refined CFO for the k+1 packet), holding the predetermined number of packets (e.g., window length) constant (or potentially modifying the window length), and comparing a later-received CFO (from the k-th packet). In some variations, the refined CFO for the k+1 packet may be based on evaluating various unfiltered CFOs. In some cases, the CFOs may include refined CFOs for at least some of the previous packets up to the k-th packet (using the above formula or another method). In other cases, however, the CFOs may include raw, unfiltered CFOs estimated or determined directly from the received DL or UL transmissions. In other cases, the CFOs may include some refined CFOs and some raw CFOs estimated or determined directly from the received DL or UL transmissions.

Other operations may include various methods, operations, and techniques. As further examples, other techniques may be based on one or more filtering methods or combinations of such methods. These may include using a FIR filter, an IIR filter, a weighted filter enabling weighting of one or more values (e.g., one or more CFOs) based on various criteria, or other filtering techniques.

These determinations and related operations may be performed on a packet-by-packet basis, a group of received packets, a subset of received packets during a period, or based on another division of packets or data.

Another track state operation may include comparing a refined CFO for a packet to an oscillator threshold value. This comparison may, in some cases, allow for adjustment or modification of UL or DL data related to an oscillator based on certain circumstances while also limiting noise and over-correction stemming from constant adjustment. In some cases, this oscillator threshold value may be related to an estimated or determined clock source drift rate associated with wireless device 300 and/or other devices. For example, a measured clock source drift rate may be about 2.25 Hz, and the oscillator threshold value may be related to this drift rate as a multiple, a factor, by some other relationship. Here, the oscillator threshold value may be set at 25 Hz, which is approximately ten times the clock source drift rate. Thus, in this operation, the refined CFO may be compared to the oscillator threshold value.

Another track state operation may include adjusting a clock source (e.g., a crystal, a VCXO) based on comparing a refined CFO for a packet to an oscillator threshold value. If it is determined that the refined CFO for a packet is greater than or equal to the oscillator threshold value then this refined CFO may be applied to the clock source, and by extension this may be included with an UL or a DL transmission packet or data. In this case, the UL or the DL data may be based on the refined CFO.

Alternatively, if it is determined that the refined CFO for a packet is less than (or in some cases less than or equal to) clock source threshold then this refined CFO may not be applied to the clock source. Instead, in some cases, this refined CFO may be stored for further operations relating to other packets. In other cases, this refined CFO may be disregarded or discarded.

As another alternative, if the refined CFO is less than the clock source threshold then either the refined CFO may be stored or a refined CFO for a previous packet may instead be stored and used for further operations relating to other packets. If the later refined CFO does not vary by a threshold amount when compared to an earlier refined CFO, the system may determine that the earlier refined CFO could be used and may set the later refined CFO to the earlier refined CFO.

Another example track state operation may include evaluating whether a correction should be made based on operations that may have previously occurred. For example, a first track state operation may include applying a refined CFO to a clock source at first time, with the refined CFO being performed based on CFO filtering operations. Then, a second track state operation may include evaluating whether a correction should be made. This evaluation may be based on whether a first correction was previously made.

In some cases, this evaluation may be based on an elapsed time between a first correction and a second time of a potential second correction. In this case, if the time since the first correction is equal to or greater than a predetermined time threshold, then the second correction may be made. If not, then the second correction may be delayed, until the predetermined time threshold is met, or another independent evaluation of whether an adjustment to be can be performed after the predetermined time threshold has been satisfied.

In some cases, this evaluation may be based on a predetermined packet count, which may relate to the number of packets received, identified, evaluated, or filtered since a first time of a first correction and a second time of a potential second correction. In this case, if the number of packets received, identified, evaluated, or filtered (among other operations) since the first correction is equal to or greater than a predetermined packet count, then the second correction may be made. If not, then the second correction may be delayed, until the predetermined packet count is met, or another evaluation of whether an adjustment to be can be performed after the predetermined packet count has been satisfied. For example, if only 5 packets have been filtered since a first correction was made and the packet count was 30 packets, as one example, then the second potential correction would be delayed or discarded. This example merely describes one case and other examples are specifically contemplated and fall within the scope of this disclosure.

In some cases, evaluating whether a correction should be made based on operations that may have previously occurred allows for correction at appropriate times while also minimizing noise, which may be introduced by VCXO corrections, and preventing constant over-correction due to variations in the signals or the CFOs.

In some examples, other adjustments may be made during one or more states (e.g., a ramp state, a track state). For example, an additional adjustment may be made to account for a drift of a CFO-related signal, which is one of the sources of CFO-related error. For example, an additional adjustment may be made to account for drift associated with a crystal (e.g., an oscillator, such as a VCXO). In some situations an AP may drift between the time that a STA receives one or more DL transmissions and when the STA performs one or more operations. This may make the STA's estimates and calculations less accurate because from the start because the inherent drift associated with an AP continues even after a received DL transmission. Accordingly, a filtering operation and a related additional adjustment may be performed to account for this drift. Alternatively, in some cases, the unfiltered CFO filtering, adjustment, and precorrection may account for this drift in addition to other sources of error.

In some cases, based at least in part on one or more operations during the initial state 310, the ramp state 315, or the track state 320, a sleep state 325 may be entered via one of transitions 385, 375, or 360, respectively. In some cases, a sleep state may be entered via one of transitions 385, 375, or 360 based on an elapsed period of time since one or more previous transmissions. If no transmissions have been received for a predetermined period, sleep state 325 may be entered to conserve power and filtering and other operations can cease for a period. Upon one or more conditions described in the present disclosure (e.g., receiving an additional transmission, determining a number of unfiltered CFOs), wireless device 300 may enter initial state 310 (via transition 370). In some cases, a sleep state 325 may be a temporary state that is entered from another state, and the other state may be reentered from the sleep state. Alternatively, after entering the sleep state 325 from another state (e.g., ramp state 315, track state 320), an initial state 310 may be entered. In some cases, sleep state 325 may be entered based on one or more conditions related to a DL or an UL transmission, CFO filtering, or other operations.

As one example, sleep state 325 may be entered from track state 320 when the period between the reception of one packet and the reception of a second packet is greater than a predetermined threshold. Or, in some cases, sleep state 325 may be entered from track state 320 when the period from the reception of one packet is greater than a predetermined threshold, which may signify that no more DL or UL transmissions will be received at this time or that CFO filtering or correction operations will not be needed. The sleep state 325 may continue to occur until the one or more conditions is satisfied, as signaled by action 365. In some cases, reentering the initial state 310 may begin the state again and cause an operational sequence from the initial state 310 to the ramp state 315 and then to the track state 320.

This disclosure highlights at least some differences from and improvements over other methods and techniques. As one example, other CFO processes may be performed by specially-designed hardware or physical circuitry that rely on complex algorithms and interactions between different parts or elements to function. Here, the described methods and techniques may be based on different states or stages (e.g., initial state, ramp state, track state) that may be designed for and applied to various applications and devices, and may rely on uncomplicated operations and functions—enabling faster and more efficient processing and operation. In some cases, the different states or stages may be dependent on one or more other states or stages with at least one including a filter process, and the way the transitions between states are executed may facilitate accurate and measured responses for the UL or the DL transmission of information. In some cases, the frequency may be corrected using one or more techniques or methods, but is not tied to the physical circuitry.

In addition, other CFO processes may be related to feeding altered CFOs back through a decoder or may be related to only certain transmissions and/or receiving components that may be associated with a loop. Here, the present methods and techniques may be based on precorrection of filtered CFOs for transmitting UL communications, including, but not limited to, UL MU-MIMO communications. In addition, other CFO processes may be based on initially approximating one or more unfiltered CFOs (compared to a real CFO), Here, the described methods and techniques may be based on filtering the determined/estimated, unfiltered CFOs to better determine the actual CFOs that may apply to one packet or transmission or multiple packets or transmissions. In addition, the described methods and techniques may facilitate filtering the unfiltered CFOs to determine one or more refined CFOs, that may then be used for precorrection before UL or other transmissions.

In addition, other CFO processes may be based on feeding altered CFOs back through a decoder or may be related to only DL transmissions and/or receiving components that may be associated with a loop. In addition, other CFO processes may be related to adjusting after operations, including those relating to a clock. Here, the described methods and techniques may be based on precorrection before a crystal or an oscillator operation or adjustment. Other CFO processes may be based on constant or continuous updating, which may, in some cases, introduce unnecessary noise, create other problems, and make operations and related performance complex and rely on more robust components, analysis, and organization. Here, the described methods and techniques may relate to deliberate and precise updating of a crystal or other component or element, which may be based on a duration or a number of packets since a previous update, among other factors.

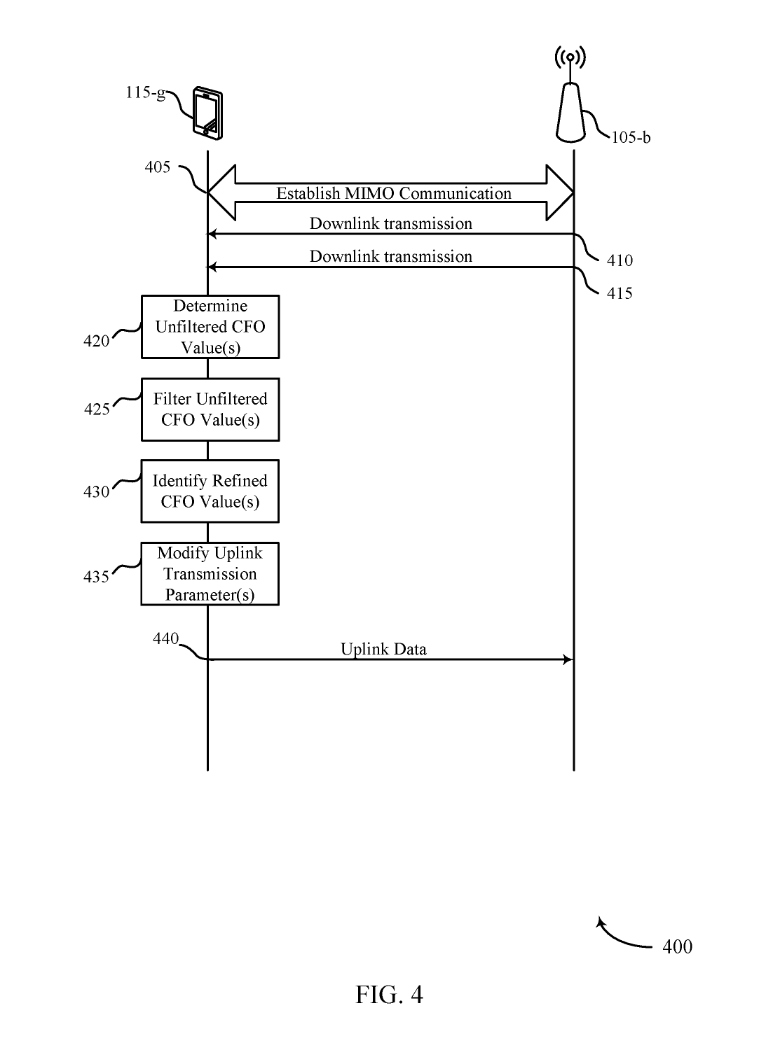

FIG. 4 illustrates an example of a process flow 400 for filtering carrier frequency offset in a MIMO environment. In some cases, process flow 400 may represent aspects of techniques performed by a STA 115 or AP 105 as described with reference to FIG. 1. This example merely describes one case and other examples are specifically contemplated and fall within the scope of this disclosure. Specifically, though the respective processes are shown relating to a AP 105-b and STA 115-g using various UL and DL transmissions, similar operations could be performed by different devices, including different types of devices. For examples, the operations shown as being performed by STA 115-g may instead by performed by AP 105-b, and vice-versa.

At step 405, AP 105-b may establish communication with STA 115-g through a MIMO system. STA 115-g may be one of several wireless devices in communication, specifically in MIMO communication, with AP 105-b. At step 410, AP 105-b may transmit a first DL transmission to STA 115-g, which may include CFO data or data indicating an unfiltered CFO. At step 415, AP 105-b may transmit a second DL transmission to STA 115-g, which may include CFO data or data indicating an unfiltered CFO. In some cases, AP 105-b may transmit multiple DL transmissions to STA 115-g before, during, or after other steps shown in FIG. 4 or otherwise described in the present disclosure. In some cases, STA 115-g may receive one or more DL transmissions at different times and may perform one or more operations, including those shown and described with reference to FIG. 4, for one or more packets while continuing to receive other DL transmissions and performing other operations.

At step 420, STA 115-g may determine one or more unfiltered CFOs. In some examples, one example of determining one or more unfiltered CFOs includes estimating one or more unfiltered CFOs. As described in the present disclosure, various techniques and method may be used to determine or estimate one or more unfiltered CFOs. In some examples, the determining or estimating may be based on a received transmission (e.g., a received DL transmission). As one example, an unfiltered CFO may be determined for each packet received at a device, which may be based on a single transmission or multiple transmissions. In some examples, the unfiltered CFO value may be determined based on at least some of the symbols contained in a portion of a transmission received (e.g., a preamble associated with a received transmission) such as a received packet (e.g., a trigger packet). This determination may be based on using one or more algorithms relating to the symbols associated with the received transmission or detecting information in the trigger packet relating to the carrier frequency of the transmitted device (e.g., an AP), among other methods. In some examples, the unfiltered CFO may be determined based on comparing information associated with a received transmission and other information relating to previous and/or subsequent transmissions or related data. As one example, this may include comparing symbol or trigger packet information associated with a received transmission to symbol or trigger packet information associated with one or more previous transmission and determining any differences. In some cases, this estimation may be based on one or more DL transmission received from AP 105-b. In some cases, this estimation may be based on a DL transmission that includes a trigger message that enables the STA to estimate an unfiltered CFO as a representation to a true CFO.

At step 425, STA 115-g may filter one or more unfiltered CFOs. In some cases, this filtering may include filtering estimated or unfiltered CFOs based on one or more DL transmissions, which may allow for more accurate determinations about an actual CFO. In some cases, this filtering may be based on one or more methods. As one example, this filtering may be based averaging, comparing, evaluating, ordering, or performing one or more other operations related to unfiltered CFOs.

At step 430, STA 115-g may identify one or more refined CFOs. In some cases, the refined CFOs may be based on only unfiltered CFOs, other refined CFOs, other information, or some combination of these. For example, determining a later refined CFO may be based on an earlier refined CFO, which may relate to one or more packets or DL transmissions, an unfiltered CFO of an additional packet or CFO not considered when identifying an earlier refined CFO, other information, or some combination of these.

At step 435, STA 115-g may modify one or more UL transmission parameters. In some cases, these UL transmission parameters may relate to transmissions to be transmitted to AP 105-b. These modified UL a transmission parameters may be based on the identified refined CFO(s). Modifying the UL a transmission parameter may also include adjustment based on one or more refined CFOs. In some cases, modifying the UL a transmission parameter may also be based on whether one or more previous modifications or corrections have been made, and comparing one or more parameters of the one or more previous modifications or corrections to the current potential modification. In some cases, if the one or more previous modifications or corrections of a transmission parameter occurred within a predetermined period or within a certain number of received packets or DL transmissions, then modifying the UL transmission parameter may be adjusted accordingly or avoided, as discussed in the present disclosure. In some examples, examples of a transmission parameter may include a transmission frequency, a transmission power, a periodicity of multiple transmissions, a transmission time, a transmission length, a transmission pattern, some combination, or other parameters.

At step 440, STA 115-g may transmit an UL data using the MIMO communication connection, which UL data may include modified UL data based on one or more filtered CFOs, one or more identified refined CFOs, or both, among other information.

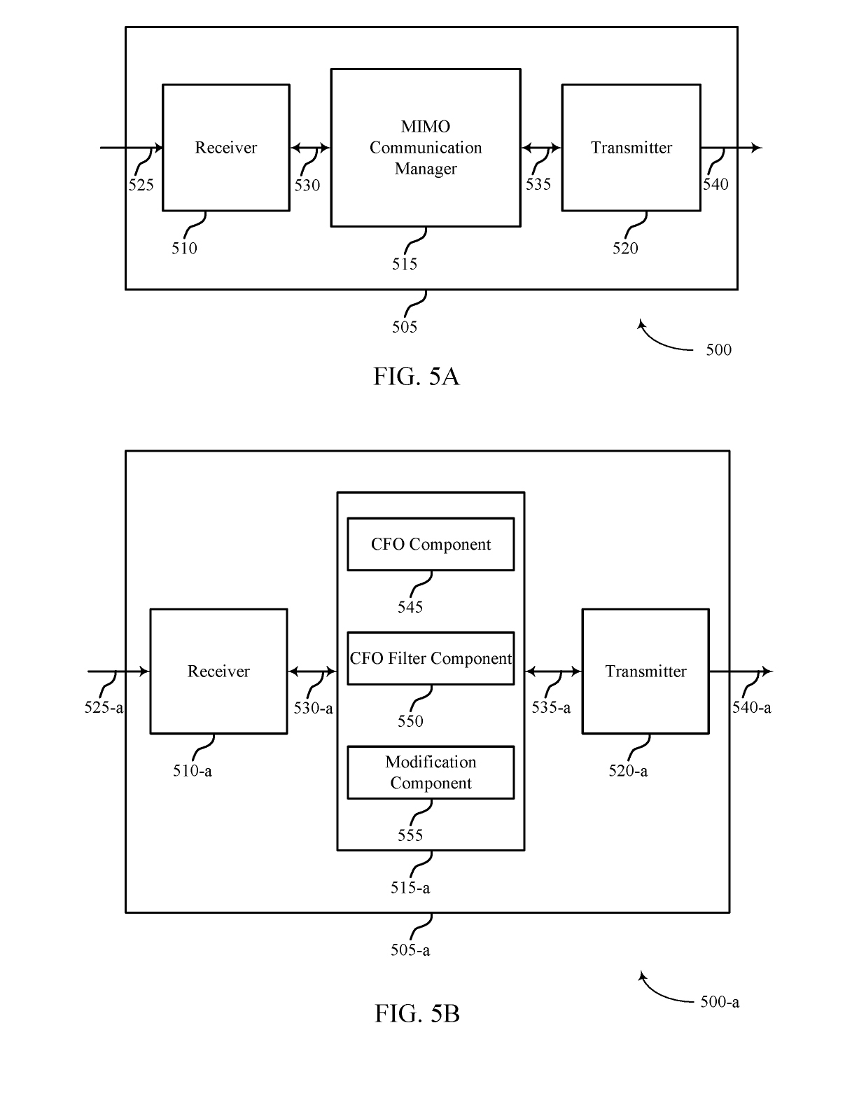

FIG. 5A shows a block diagram 500 of a device 505 that supports filtering carrier frequency offset in a MIMO environment in accordance with various aspects of the present disclosure. Device 505 may be an example of aspects of a STA 115 or an AP 105 as described with reference to FIGS. 1 and 2. Device 505 may include receiver 510, MIMO communication manager 515, and transmitter 520. Each of these components may be in communication with each other (e.g., via signals 525, 530, 535, and 540) using one or more components (e.g., a bus). Device 505 may also include a processor.

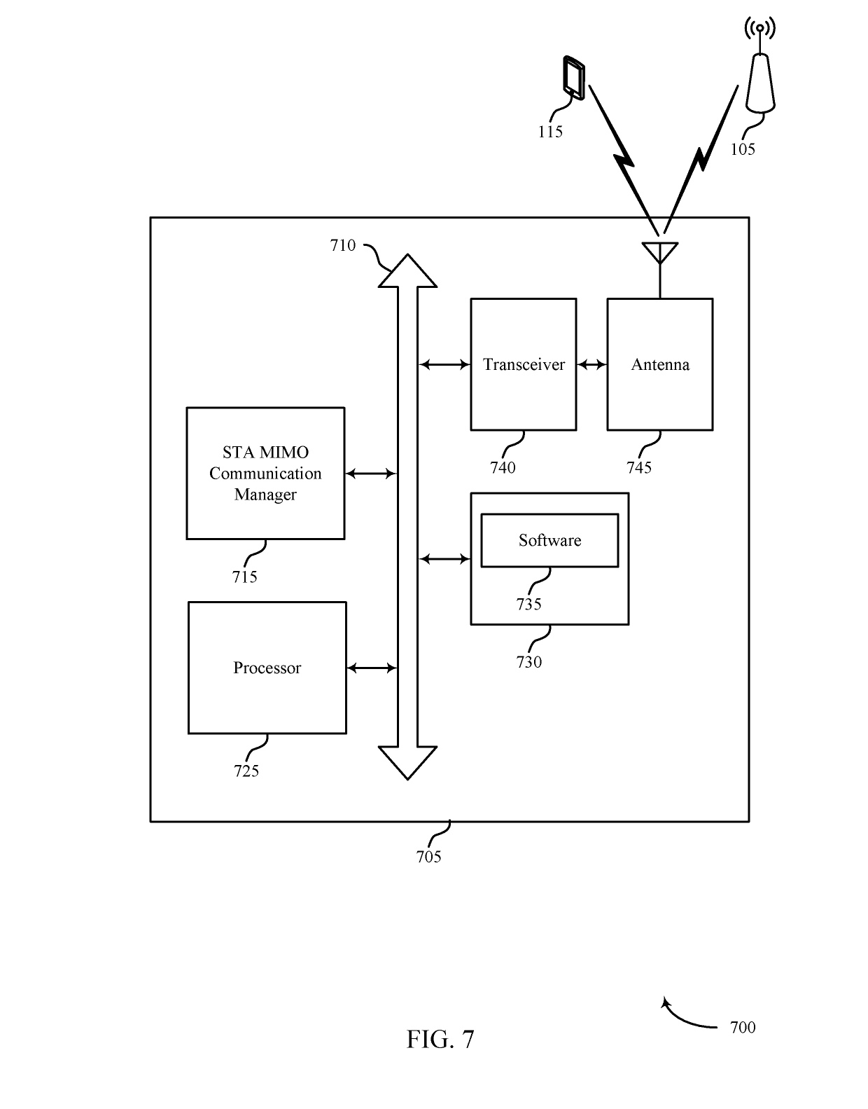

Receiver 510 may include a circuit or circuitry for receiving information such as packets, user data, or control information associated with various information channels (e.g., control channels, data channels, and information related to filtering carrier frequency offset in a MIMO environment). Information may be passed on to other components of the device. The receiver 510 may be an example of aspects of the transceiver 740 described with reference to FIG. 7. Receiver 510 may also receive a DL transmission from an AP point or an UL transmission from a STA.

MIMO communication manager 515 may be an example of aspects of the MIMO communication manager 715 described with reference to FIG. 7. In some cases, MIMO communication manager 515 may be an example of a STA MIMO communication manager. In other cases, MIMO communication manager 515 may be an example of an AP MIMO communication manager. MIMO communication manager 515 may include a circuit or circuitry for determining one or more unfiltered CFOs, filtering the one or more unfiltered CFOs to identify a refined CFO based at least in part on the one or more unfiltered CFOs and a predetermined number of packets, and modifying a transmission parameter based at least in part on the refined CFO. In some examples, components—for example as shown in FIGS. 5-7, including, but not limited to, MIMO communication manager 515—may include a circuit or circuitry for accomplishing each of these functions.

Transmitter 520 may include a circuit or circuitry for transmitting signals generated by other components of the device. In some examples, transmitter 520 may include a circuit or circuitry for transmitting a signal in a MU-MIMO environment based at least in part on the modified transmission parameter. In some examples, the transmitter 520 may be collocated with a receiver 510 in a transceiver component. For example, the transmitter 520 may be an example of aspects of the transceiver 740 described with reference to FIG. 7. The transmitter 520 may include a single antenna, or it may include a set of antennas. Transmitter 520 may transmit UL or DL data in an MU-MIMO environment based on the modified data.

FIG. 5B shows a block diagram 500-a of a device 505-a that supports filtering carrier frequency offset in a MIMO environment in accordance with various aspects of the present disclosure. Device 505-a may be an example of aspects of a device 505, a STA 115, or an AP 105 as described with reference to FIGS. 1, 2 and 5A. Device 505-a may include receiver 510-a, MIMO communication manager 515-a, and transmitter 520-a. Each of these components may be in communication with each other (e.g., via signals 525-a, 530-a, 535-a, and 540-a) using one or more components (e.g., a bus). Device 505-a may also include a processor.

Receiver 510-a may include a circuit or circuitry for receiving information such as packets, user data, or control information associated with various information channels (e.g., control channels, data channels, and information related to filtering carrier frequency offset in a MIMO environment, etc.). Information may be passed on to other components of the device. The receiver 510-a may be an example of aspects of the transceiver 740 described with reference to FIG. 7.

MIMO communication manager 515-a may be an example of aspects of the MIMO communication manager 715 described with reference to FIG. 7. MIMO communication manager 515-a may also include CFO component 545, CFO filter component 550, and modification component 555.

CFO component 545 may include a circuit or circuitry for determining one or more unfiltered CFOs, comparing one or more unfiltered CFOs and the refined CFO, adjusting the one or more unfiltered CFOs based at least in part on the comparison, updating the refined CFO based on the adjusted unfiltered CFO, and determining one or more unfiltered CFOs based on a received transmission or transmissions.

CFO filter component 550 may include a circuit or circuitry for filtering the one or more unfiltered CFOs to identify a refined CFO based at least in part on the one or more unfiltered CFOs and a predetermined number of packets. CFO filter component 550 may include a circuit or circuitry for filtering the unfiltered CFO to identify a second refined CFO of the second packet set. In some cases, the filtering may include using a moving average, among other techniques. In some cases, filtering the unfiltered CFO to identify the refined CFO of the packet set may include filtering the packet set at a first time.

Modification component 555 may include a circuit or circuitry for modifying one or more transmission parameters based on the refined CFO, and determine whether to modify one or more transmission parameters based on comparing the refined CFO and an oscillator adjustment value. Modification component 555 may also include a circuit or circuitry for determining that a first modification of data based on the refined CFO occurred at a first time, and modify one or more transmission parameters at a second time using a second refined CFO based on the comparison. Modification component 555 may include a circuit or circuitry for precorrecting one or more transmission parameters or data based at least in part on the unfiltered CFO, or the refined CFO, or some combination thereof.

Transmitter 520-a may include a circuit or circuitry for transmitting signals generated by other components of the device. In some examples, the transmitter 520-a may be collocated with a receiver 510-a in a transceiver component. For example, the transmitter 520-a may be an example of aspects of the transceiver 740 described with reference to FIG. 7. The transmitter 520-a may include a single antenna, or it may include a set of antennas.

In some examples, components—for example those shown in FIGS. 5A and 5B, including, but not limited to, MIMO communication manager 515, CFO component 545, CFO filter component 550, or modification component 555—may include a circuit or circuitry for accomplishing each of these functions.

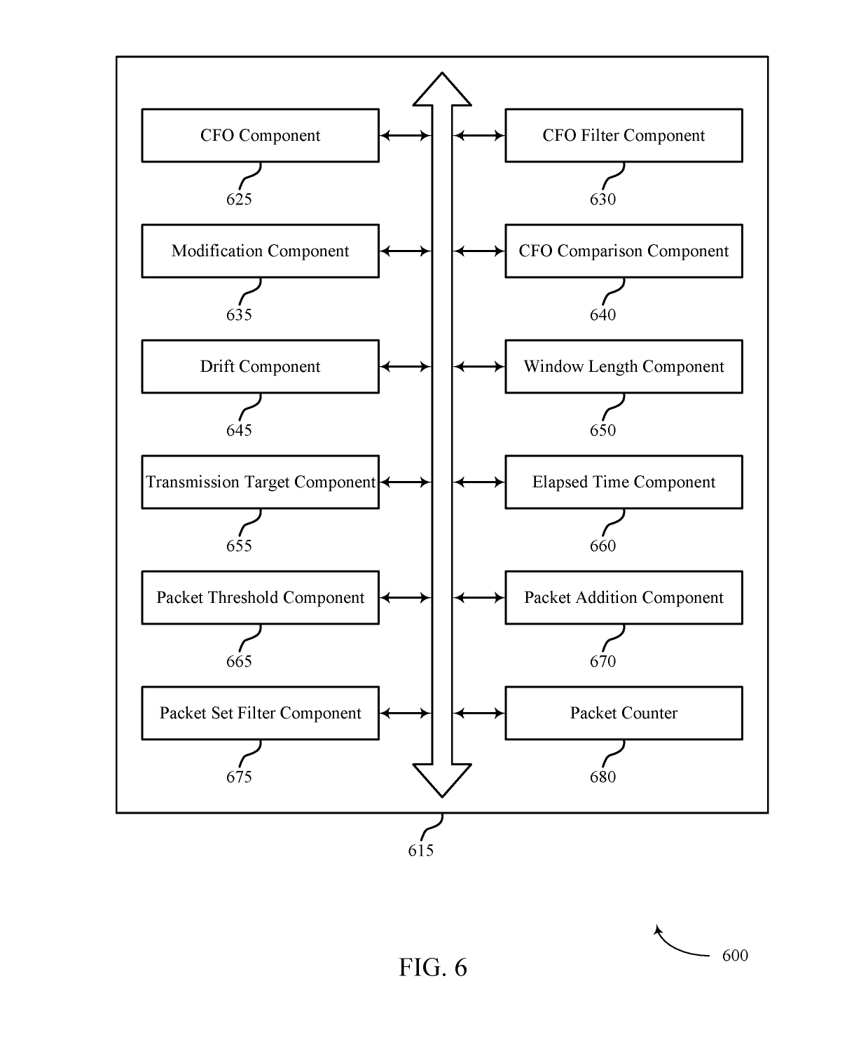

FIG. 6 shows a block diagram 600 of a MIMO communication manager 615 that supports filtering CFO in a MIMO environment in accordance with various aspects of the present disclosure. The MIMO communication manager 615 may be an example of aspects of a MIMO communication manager 515, a MIMO communication manager 515-a, or a MIMO communication manager 715 described with reference to FIGS. 5A, 5B, and 7. The MIMO communication manager 615 may include CFO component 625, CFO filter 630, modification component 635, CFO comparison component 640, drift component 645, window length component 650, transmission target component 655, elapsed time component 660, packet threshold component 665, packet addition component 670, packet set filter component 675, and packet counter 680. Each of these components may communicate, directly or indirectly, with one another (e.g., via one or more buses).

CFO component 625 may include a circuit or circuitry for determining one or more unfiltered CFOs, comparing one or more unfiltered CFOs and the refined CFO, adjusting the one or more unfiltered CFOs based at least in part on the comparison, updating the refined CFO based on the adjusted unfiltered CFO, and estimating one or more unfiltered CFOs of a second packet set based on the received transmission or transmissions.

CFO filter 630 may include a circuit or circuitry for filtering the one or more unfiltered CFOs to identify a refined CFO based at least in part on the one or more unfiltered CFOs and a predetermined number of packets. CFO filter 630 may also include a circuit or circuitry for filtering the one or more additional unfiltered CFOs to identify a second refined CFO. In some cases, filtering the unfiltered CFO to identify the refined CFO of the packet set may include filtering the one or more unfiltered CFOs at a first time.

Modification component 635 may include a circuit or circuitry for modifying one or more transmission parameters based on the refined CFO, determining whether to modify one or more transmission parameters based on comparing the refined CFO and an oscillator adjustment value. Modification component 635 may also include a circuit or circuitry for determining that a first modification of a one or more transmission parameters based on the refined CFO occurred at a first time, and modifying UL one or more transmission parameters at a second time using a second refined CFO based on the comparison.

CFO comparison component 640 may include a circuit or circuitry for comparing an unfiltered CFO with the refined CFO, setting the refined CFO based on the comparison, and disregarding the unfiltered CFO based on the comparison. CFO comparison component 640 may also include a circuit or circuitry for comparing the refined CFO relative to a threshold adjustment value, where modifying one or more transmission parameters related to an UL transmission is based on the comparison, and comparing an unfiltered CFO with the refined CFO. CFO comparison component 640 may include a circuit or circuitry for adjusting the unfiltered CFO based on the comparison, and comparing the refined CFO with the second refined CFO, where the modified transmission parameter is based on the comparison.

Drift component 645 may include a circuit or circuitry for determining a drift value associated with a clock source and determining whether to adjust the refined CFO based on the determined drift value and an elapsed time, where the modified transmission parameter is based on determining whether to adjust the refined CFO.

Window length component 650 may include a circuit or circuitry for determining the predetermined number of packets (e.g., a window length) for filtering based on a clock source, where determining the refined CFO is based on the determined predetermined number of packets (e.g., window length).

Transmission target component 655 may include a circuit or circuitry for determining whether the received transmissions from a device are intended for a STA or an AP, where estimating an unfiltered CFO of the packet set is based on determining whether the received transmissions from the device (e.g., an AP, a STA) are intended for the STA or the AP.

Elapsed time component 660 may include a circuit or circuitry for comparing an elapsed time between two received transmissions, where determining the refined CFO of the packet set by filtering is based on a packet received after the elapsed time.

Packet threshold component 665 may include a circuit or circuitry for identifying a number of received receiving transmissions or packets from a device and comparing the number of received transmissions or packets to a packet threshold value, where the filtering is performed on a single received packet, multiple received packets, or a number of received packets based on the comparison.

Packet addition component 670 may include a circuit or circuitry for adding at least one other packet to the packet set based on receiving another transmission. This other transmission may be received from the same source as an earlier transmission or from a different source, such as a received transmission after a first time. Packet set filter component 675 may filter a subset of the one or more unfiltered CFOs and/or one or more refined CFOs. In some cases, packet set filter component 675 may filter a subset of the one or more unfiltered CFOs based at least in part on the received another transmission. Packet counter 680 may include a circuit or circuitry for comparing a number of received packets since the first time to a packet counter.

FIG. 7 shows a diagram of a system 700 including a device 705 that supports filtering CFO in a MIMO environment in accordance with various aspects of the present disclosure. Device 705 may be an example of a device 505, device 505-a, a STA 115, or an AP 105 as described above with reference to FIGS. 1-6.

Device 705 may include components for bi-directional voice and data communications including components for transmitting and receiving communications, including MIMO communication manager 715, processor 725, memory 730, computer-executable software 735, transceiver 740, and antenna 745.

Processor 725 may include an intelligent hardware device, (e.g., a central processing unit (CPU), a microcontroller, an application specific integrated circuit (ASIC), etc.) Memory 730 may include random access memory (RAM) and read only memory (ROM). The memory 730 may store computer-readable, computer-executable software 735 including instructions that, when executed, cause the processor to perform various functions described herein. In some cases, the memory 730 can contain, among other things, a Basic Input-Output system (BIOS) which may control basic hardware and/or software operation such as the interaction with peripheral components or devices.

Computer-executable software 735 may include code to implement aspects of the present disclosure, including code to support filtering CFO in a MIMO environment. Computer-executable software 735 can be stored in a non-transitory computer-readable medium such as system memory or other memory. In some cases, the computer-executable software 735 may not be directly executable by the processor but may cause a computer (e.g., when compiled and executed) to perform functions described herein.

Transceiver 740 may communicate bi-directionally, via one or more antennas, wired, or wireless links as described above. For example, the transceiver 740 may represent a wireless transceiver and may communicate bi-directionally with another wireless transceiver. The transceiver 740 may also include a modem to modulate the packets and provide the modulated packets to the antennas for transmission, and to demodulate packets received from the antennas. In some cases, the wireless device may include an antenna 745. However, in some cases the device may have more than one antenna 745, which may be capable of concurrently transmitting or receiving multiple wireless transmissions.

The components of device 505, wireless device 605, and MU-MIMO CFO filtering component 135, MIMO communication manager 515, 715, and the components of system 700 may, individually or collectively, be implemented with at least one ASIC adapted to perform some or all of the applicable functions in hardware. Alternatively, the functions may be performed by one or more other processing units (or cores), on at least one integrated circuit (IC). In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

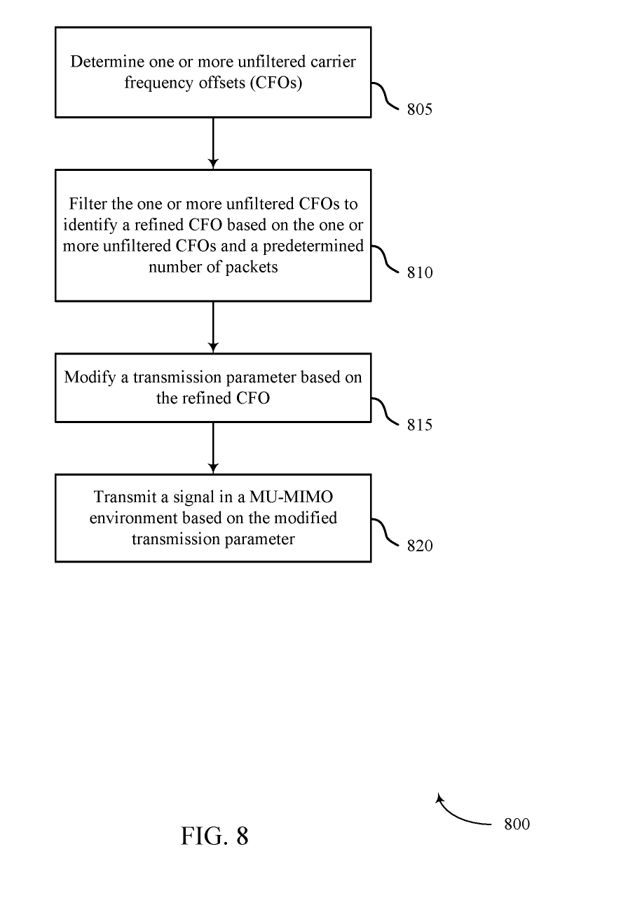

FIG. 8 shows a flowchart illustrating a method 800 for filtering carrier frequency offset in a MIMO environment in accordance with various aspects of the present disclosure. The operations of method 800 may be implemented by a STA 115 or its components as described herein. In other examples, the operations of method 800 may be implemented by a AP 105 or its components as described herein. For example, the operations of method 800 may be performed by a MIMO communication manager, which may be a STA MIMO communication manager or an AP MIMO communication manager, as described with reference to FIGS. 5A through 6. In some examples, a STA 115 or an AP 105 may execute a set of codes to control the functional elements of the device to perform the functions described below. Additionally or alternatively, the STA 115 or the AP 105 may perform aspects of the functions described below using special-purpose hardware.

At block 805, a device may determine one or more unfiltered CFOs. In some examples, the STA 115 may determine one or more unfiltered CFOs of a packet set of the received DL transmission(s). In some examples, the AP 105 may determine one or more unfiltered CFOs of a packet set of the received UL transmission(s). The operations of block 810 may be performed according to the methods described with reference to FIGS. 2 through 4. In certain examples, aspects of the operations of block 810 may be performed by a CFO component as described with reference to FIGS. 5A through 6.

At block 810, the device may filter the one or more unfiltered CFOs to identify a refined CFO based at least in part on the one or more unfiltered CFOs and a predetermined number of packets. In some examples, the STA 115 or the AP 105 filter the one or more unfiltered CFOs to identify a refined CFO based at least in part on the one or more unfiltered CFOs and a predetermined number of packets. The operations of block 815 may be performed according to the methods described with reference to FIGS. 2 through 4. In certain examples, aspects of the operations of block 815 may be performed by a CFO filter as described with reference to FIGS. 5A through 6.

At block 815, the device may modify a transmission parameter based at least in part on the refined CFO. In some examples, the STA 115 may modify one or more UL transmission parameters based on the refined CFO. In some examples, the AP 105 may modify one or more DL transmission parameters based on the refined CFO. The operations of block 820 may be performed according to the methods described with reference to FIGS. 2 through 4. In certain examples, aspects of the operations of block 820 may be performed by a modification component 555 or 635 as described with reference to FIGS. 5A through 6.

At block 820, the device may transmit a signal in a MU-MIMO environment based at least in part on the modified transmission parameter. In some examples, the STA 115 may transmit an UL signal in an UL MU-MIMO environment based at least in part on one or more modified transmission parameters. In some examples, the AP 105 may transmit a DL data in a DL MU-MIMO environment based at least in part on one or more modified transmission parameters. In some examples, the STA 115 may transmit UL data in an UL MU-MIMO environment based on one or more modified transmission parameters. In some examples, the AP 105 may transmit DL data in a DL MU-MIMO environment based on one or more modified transmission parameters. The operations of block 825 may be performed according to the methods described with reference to FIGS. 2 through 4. In certain examples, aspects of the operations of block 825 may be performed by a transmitter as described with reference to FIGS. 5A through 6.

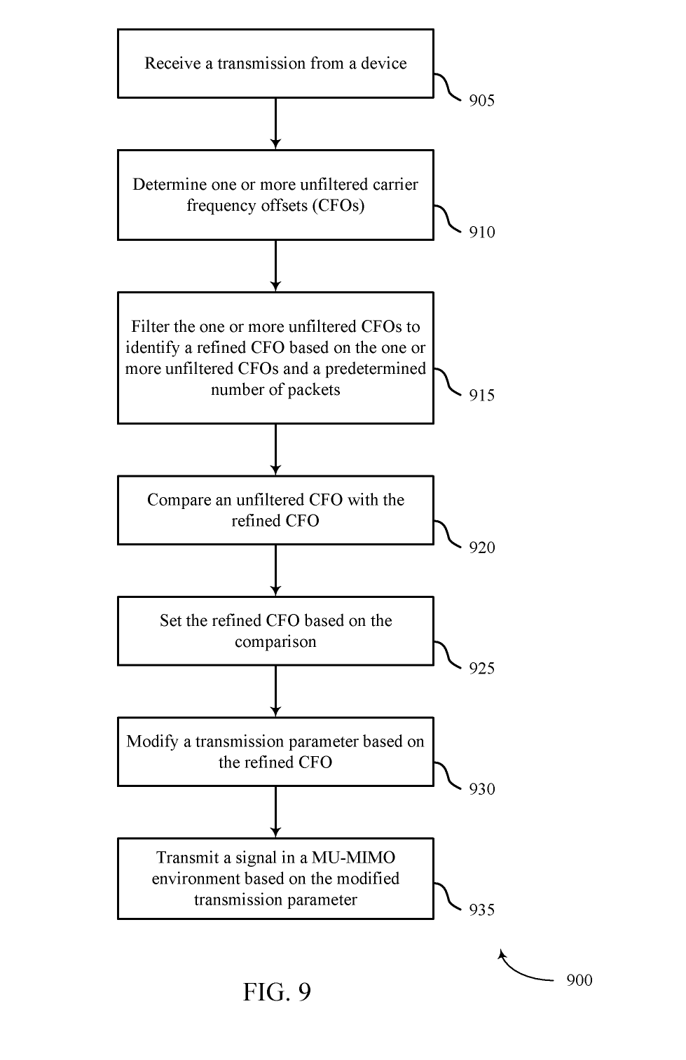

FIG. 9 shows a flowchart illustrating a method 900 for filtering CFO in a MIMO environment in accordance with various aspects of the present disclosure. The operations of method 900 may be implemented by a STA 115 or its components as described herein. In other examples, the operations of method 900 may be implemented by an AP 105 or its components as described herein. For example, the operations of method 900 may be performed by a MIMO communication manager, which may be a STA MIMO communication manager or an AP MIMO communication manager, as described with reference to FIGS. 5A through 6. In some examples, a STA 115 or an AP 105 may execute a set of codes to control the functional elements of the device to perform the functions described below. Additionally or alternatively, the STA 115 or the AP 105 may perform aspects of the functions described below using special-purpose hardware.

At block 905, a device may receive a transmission from another device. In some examples, the transmission may be a DL transmission received by STA 115 from an AP 105. In some examples, the transmission may be an UL transmission received by an AP 105 from a STA 115. The operations of block 905 may be performed according to the methods described with reference to FIGS. 2 through 4. In certain examples, aspects of the operations of block 905 may be performed by a receiver 510 or 510-a as described with reference to FIGS. 5A through 6.

At block 910, the device may determine one or more unfiltered CFOs. In some examples, the STA 115 may determine one or more unfiltered CFOs of a packet set of the received DL transmission(s). In some examples, the AP 105 may determine one or more unfiltered CFOs of a packet set of the received UL transmission(s). The operations of block 910 may be performed according to the methods described with reference to FIGS. 2 through 4. In certain examples, aspects of the operations of block 910 may be performed by a CFO component 545 or 625 as described with reference to FIGS. 5A through 6.

At block 915, the device may filter the one or more unfiltered CFOs to identify a refined CFO based at least in part on the one or more unfiltered CFOs and a predetermined number of packets. In some examples, the STA 115 or the AP 105 filter the one or more unfiltered CFOs to identify a refined CFO based at least in part on the one or more unfiltered CFOs and a predetermined number of packets. The operations of block 915 may be performed according to the methods described with reference to FIGS. 2 through 4. In certain examples, aspects of the operations of block 915 may be performed by a CFO filter component 550 or 630 as described with reference to FIGS. 5A through 6.

In some examples, the STA 115 or the AP 105 may additionally or alternatively determine the predetermined number of packets based on a clock source, where determining the refined CFO is based on the determined window length. These operations may be performed according to the methods described with reference to FIGS. 2 through 4. In certain examples, aspects of these operations may be performed by a window length component 650 as described with reference to FIGS. 5A through 6.

At block 920, a device may compare an unfiltered CFO with the refined CFO. In some examples, the STA 115 or the AP 105 may compare an unfiltered CFO with the refined CFO. The operations of block 920 may be performed according to the methods described with reference to FIGS. 2 through 4. In certain examples, aspects of the operations of block 920 may be performed by a CFO comparison component 640 as described with reference to FIGS. 5A through 6.

At block 925, the device may set the refined CFO based on the comparison. In some examples, the STA 115 or the AP 105 may set the refined CFO based on the comparison. The operations of block 925 may be performed according to the methods described with reference to FIGS. 2 through 4. In certain examples, aspects of the operations of block 925 may be performed by a CFO comparison component 640 as described with reference to FIGS. 5A through 6.

In some examples, the STA 115 or the AP 105 may additionally or alternatively disregard one or more unfiltered CFOs based on the comparison. This disregarding may be based on a whether the unfiltered CFO(s), which may or may not be an additional CFO not previously considered, is different from or outside of a predetermined window from the refined CFO or unfiltered CFO(s). For example, based on the comparison it may be determined that the unfiltered CFO is an outlier or an otherwise less accurate or less valuable measurement, which may be based on comparing the unfiltered CFO using statistical, mathematical, or other analysis (e.g., calculating a standard deviation). These operations may be performed according to the methods described with reference to FIGS. 2 through 4. In certain examples, aspects of these operations may be performed by a CFO comparison component 640 as described with reference to FIGS. 5A through 6.

In some examples, the STA 115 or the AP 105 may additionally or alternatively determine a drift value associated with a clock source. The STA 115 or the AP 105 may additionally or alternatively determine whether to adjust the refined CFO based on the determined drift value and an elapsed time. In some cases, the modified data is based on determining whether to adjust the refined CFO. These operations may be performed according to the methods described with reference to FIGS. 2 through 4. In certain examples, aspects of these operations may be performed by a drift component 645 as described with reference to FIGS. 5A through 6.

In some examples, the STA 115 or the AP 105 may additionally or alternatively compare the refined CFO relative to a threshold adjustment value. In some cases, modifying one or more transmission parameters is based on the comparison. These operations may be performed according to the methods described with reference to FIGS. 2 through 4. In certain examples, aspects of these operations may be performed by a CFO comparison component 640 as described with reference to FIGS. 5A through 6.

At block 930, the device may modify a transmission parameter based at least in part on the refined CFO. In some examples, the STA 115 may modify one or more UL transmission parameters based on the refined CFO. In some examples, the AP 105 may modify one or more DL transmission parameters based on the refined CFO. The operations of block 930 may be performed according to the methods described with reference to FIGS. 2 through 4. In certain examples, aspects of the operations of block 930 may be performed by a modification component 555 or 635 as described with reference to FIGS. 5A through 6.

At block 935, the device may transmit a signal in a MU-MIMO environment based at least in part on the modified transmission parameter. In some examples, the STA 115 may transmit an UL signal in an UL MU-MIMO environment based at least in part on one or more modified transmission parameters. In some examples, the AP 105 may transmit a DL data in a DL MU-MIMO environment based at least in part on one or more modified transmission parameters. The operations of block 935 may be performed according to the methods described with reference to FIGS. 2 through 4. In certain examples, aspects of the operations of block 935 may be performed by a transmitter 520 or 520-a as described with reference to FIGS. 5A through 6.

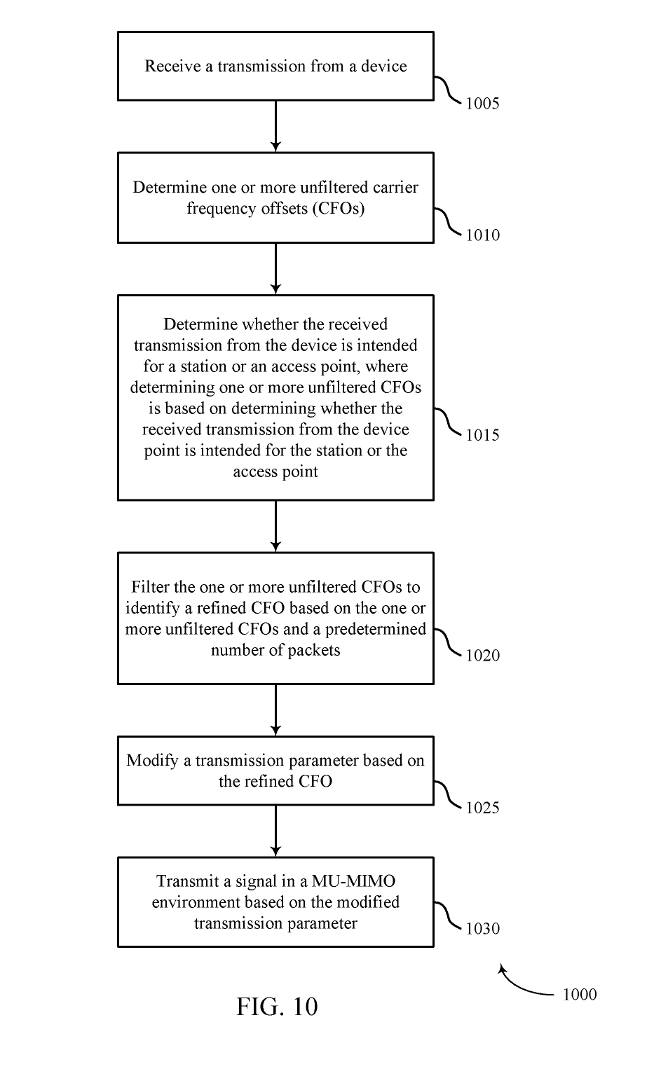

FIG. 10 shows a flowchart illustrating a method 1000 for filtering carrier frequency offset in a MIMO environment in accordance with various aspects of the present disclosure. The operations of method 1000 may be implemented by a STA 115 or its components as described herein. In other examples, the operations of method 1000 may be implemented by an AP 105 or its components as described herein. For example, the operations of method 1000 may be performed by a MIMO communication manager 515 or 515-a, which may be a STA MIMO communication manager or an AP MIMO communication manager, as described with reference to FIGS. 5A through 6. In some examples, a STA 115 or an AP 105 may execute a set of codes to control the functional elements of the device to perform the functions described below. Additionally or alternatively, the STA 115 or the AP 105 may perform aspects of the functions described below using special-purpose hardware.

At block 1005, a device may receive a transmission from another device. In some examples, the transmission may be a DL transmission received by STA 115 from an AP 105. In some examples, the transmission may be an UL transmission received by an AP 105 from a STA 115. The operations of block 1005 may be performed according to the methods described with reference to FIGS. 2 through 4. In certain examples, aspects of the operations of block 1005 may be performed by a receiver 510 or 510-a as described with reference to FIGS. 5A through 6.

At block 1010, the device may determine one or more unfiltered CFOs. In some examples, the STA 115 may determine one or more unfiltered CFOs of a packet set of the received DL transmission(s). In some examples, the AP 105 may determine one or more unfiltered CFOs of a packet set of the received UL transmission(s). The operations of block 1010 may be performed according to the methods described with reference to FIGS. 2 through 4. In certain examples, aspects of the operations of block 1010 may be performed by a CFO component 545 as described with reference to FIGS. 5A through 6.

In some examples, the STA 115 or the AP 105 may additionally or alternatively identify a number of received transmissions from a device. These operations may be performed according to the methods described with reference to FIGS. 2 through 4. In certain examples, aspects of these operations may be performed by a CFO comparison component 640 as described with reference to FIGS. 5A through 6.

In some examples, the STA 115 or the AP 105 may additionally or alternatively compare the number of received transmissions or the number of received packets related to some transmissions to a packet threshold value, where the filtering is performed on a single received packet or multiple received packets based on the comparison. These operations may be performed according to the methods described with reference to FIGS. 2 through 4. In certain examples, aspects of these operations may be performed by a packet threshold component 665 as described with reference to FIGS. 5A through 6.

At block 1015, the STA 115 or the AP 105 may determine whether the received transmission from the device is intended for a STA or an AP, where determining the one or more unfiltered CFOs is based on determining whether the received transmission from the device point is intended for the STA or the AP. In some examples, the STA 115 or the AP 105 may determine whether one or more transmissions from the device is intended for a STA or an AP, where determining the one or more unfiltered CFOs is based on determining whether the one or more received transmissions from the device point are intended for the STA or the AP. The operations of block 1015 may be performed according to the methods described with reference to FIGS. 2 through 4. In certain examples, aspects of the operations of block 1015 may be performed by a transmission target component 655 as described with reference to FIGS. 5A through 6.

In some examples, the STA 115 or the AP 105 may additionally or alternatively compare an elapsed time between two received transmissions. In some cases, determining the refined CFO of the packet set by filtering is based one or more packets received after the elapsed time. These operations may be performed according to the methods described with reference to FIGS. 2 through 3. In certain examples, aspects of these operations may be performed by an elapsed time component 660 as described with reference to FIGS. 5A through 6.

At block 1020, the device may filter the one or more unfiltered CFOs to identify a refined CFO based at least in part on the one or more unfiltered CFOs and a predetermined number of packets. In some examples, the STA 115 or the AP 105 filter the one or more unfiltered CFOs to identify a refined CFO based at least in part on the one or more unfiltered CFOs and a predetermined number of packets. The operations of block 1020 may be performed according to the methods described with reference to FIGS. 2 through 4. In certain examples, aspects of the operations of block 1020 may be performed by a CFO filter component 550 or 630 as described with reference to FIGS. 5A through 6.

In some examples, the STA 115 or the AP 105 may additionally or alternatively determine whether to modify one or more transmission parameters based on comparing the refined CFO and an oscillator adjustment value. In some cases, this determination may be based on comparing the refined CFO and the oscillator adjustment value, and determining whether to modify the one or more transmission parameters based on whether the refined CFO is greater than, equal to, or less than the oscillator adjustment value. In some cases, the data may be modified when the refined CFO is greater than or equal to the oscillator adjustment value. These operations may be performed according to the methods described with reference to FIGS. 2 through 4. In certain examples, aspects of these operations may be performed by a CFO comparison component 640 as described with reference to FIGS. 5A through 6.

In some examples, the STA 115 or the AP 105 may additionally or alternatively compare an unfiltered CFO with the refined CFO, adjust the unfiltered CFO based on the comparison, and update the refined CFO based on the adjusted unfiltered CFO. These operations may be performed according to the methods described with reference to FIGS. 2 through 4. In certain examples, aspects of these operations may be performed by a CFO comparison component 640 as described with reference to FIGS. 5A through 6.

In some examples, the STA 115 or the AP 105 may additionally or alternatively determine the predetermined number of packets (e.g., window length) for filtering based on a clock source. In some cases, determining the refined CFO is based on the determined predetermined number of packets. In some examples, the clock source may be a crystal, an oscillator, or a VCXO. These operations may be performed according to the methods described with reference to FIGS. 2 through 4. In certain examples, aspects of these operations may be performed by a window length component 650 as described with reference to FIGS. 5A through 6.

At block 1025, the device may modify a transmission parameter based at least in part on the refined CFO. In some examples, the STA 115 may modify one or more UL transmission parameters based on the refined CFO. In some examples, the AP 105 may modify one or more DL transmission parameters based on the refined CFO. The operations of block 1025 may be performed according to the methods described with reference to FIGS. 2 through 4. In certain examples, aspects of the operations of block 1025 may be performed by a modification component 555 or 635 as described with reference to FIGS. 5A through 6.

At block 1030, the device may transmit a signal in a MU-MIMO environment based at least in part on the modified transmission parameter. In some examples, the STA 115 may transmit an UL signal in an UL MU-MIMO environment based at least in part on one or more modified transmission parameters. In some examples, the AP 105 may transmit a DL data in a DL MU-MIMO environment based at least in part on one or more modified transmission parameters. The operations of block 1030 may be performed according to the methods described with reference to FIGS. 2 through 4. In certain examples, aspects of the operations of block 1030 may be performed by a transmitter 520 or 520-a as described with reference to FIGS. 5A through 6.

In some examples, the STA 115 or the AP 105 may additionally or alternatively precorrect a transmission timing, a transmission frequency, data, or a combination thereof based at least in part on the unfiltered CFO or the refined CFO, where transmitting the signal in the MU-MIMO environment is based on the precorrection. These operations may be performed according to the methods described with reference to FIGS. 2 through 4. In certain examples, aspects of these operations may be performed by a modification component 555 or 635 as described with reference to FIGS. 5A through 6.

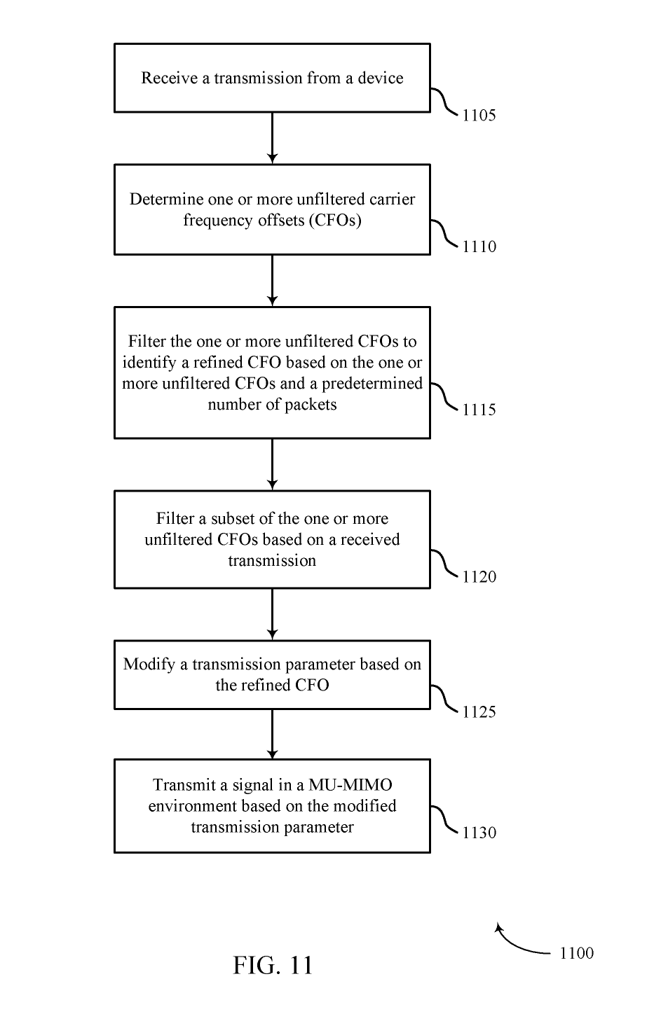

FIG. 11 shows a flowchart illustrating a method 1100 for filtering carrier frequency offset in a MIMO environment in accordance with various aspects of the present disclosure. The operations of method 1100 may be implemented by a STA 115 or its components as described herein. In other examples, the operations of method 1100 may be implemented by an AP 105 or its components as described herein. For example, the operations of method 1100 may be performed by a MIMO communication manager 515 or 515-a, which may be a STA MIMO communication manager or an AP MIMO communication manager, as described with reference to FIGS. 5A through 6. In some examples, a STA 115 or an AP 105 may execute a set of codes to control the functional elements of the device to perform the functions described below. Additionally or alternatively, the STA 115 or the AP 105 may perform aspects of the functions described below using special-purpose hardware.

At block 1105, a device may receive a transmission from another device. In some examples, the transmission may be a DL transmission received by a STA 115 from an AP 105. In some examples, the transmission may be an UL transmission received by an AP 105 from a STA 115. The operations of block 1105 may be performed according to the methods described with reference to FIGS. 2 through 4. In certain examples, aspects of the operations of block 1105 may be performed by a receiver 510 or 510-a as described with reference to FIGS. 5A through 6.

At block 1110, the device may determine one or more unfiltered CFOs. In some examples, the STA 115 may determine one or more unfiltered CFOs of a packet set of the received DL transmission(s). In some examples, the AP 105 may determine one or more unfiltered CFOs of a packet set of the received UL transmission(s). The operations of block 1110 may be performed according to the methods described with reference to FIGS. 2 through 4. In certain examples, aspects of the operations of block 1110 may be performed by a CFO component 545 or 625 as described with reference to FIGS. 5A through 6.

At block 1115, the device may filter the one or more unfiltered CFOs to identify a refined CFO based at least in part on the one or more unfiltered CFOs and a predetermined number of packets. In some examples, the STA 115 or the AP 105 filter the one or more unfiltered CFOs to identify a refined CFO based at least in part on the one or more unfiltered CFOs and a predetermined number of packets. The operations of block 1115 may be performed according to the methods described with reference to FIGS. 2 through 4. In certain examples, aspects of the operations of block 1115 may be performed by a CFO filter component 550 or 630 as described with reference to FIGS. 5A through 6.

At block 1120, the device may filter a subset of the one or more unfiltered CFOs based at least in part on a received transmission. In some cases, the filtering of the subset may occur at a second time after a first time corresponding to filtering the one or more unfiltered CFOs. In some examples, the STA 115 may filter a subset of one or more unfiltered CFOs at a second time after a first time based on a DL transmission received after the first time (i.e., an additional transmission) or before the first time (i.e., an earlier or original transmission. In some examples, the AP 105 may filter a subset of one or more unfiltered CFOs at a second time after a first time based on a UL transmission received after the first time (i.e., an additional transmission) or before the first time (i.e., an earlier or original transmission. The operations of block 1120 may be performed according to the methods described with reference to FIGS. 2 through 4. In certain examples, aspects of the operations of block 1120 may be performed by a packet set filter component 675 as described with reference to FIGS. 5A through 6.

In some examples, the STA 115 or the AP 105 may additionally or alternatively estimate an unfiltered CFO of a different packet set based on the received transmission, filter the unfiltered CFO to identify a second refined CFO of the different packet set, and compare the refined CFO and the second refined CFO. In some cases, the modified transmission parameter is based on the comparison. In some cases, different packet set includes at least part of the packet set related to the one or more unfiltered CFOs and another received packet. These operations may be performed according to the methods described with reference to FIGS. 2 through 4. In certain examples, aspects of these operations may be performed by a CFO comparison component 640 as described with reference to FIGS. 5A through 6.

In some examples, the STA 115 or the AP 105 may additionally or alternatively determine that a first modification of data based on the refined CFO occurred at a first time, compare a number of packets or transmission received since the first time to a counter (e.g., a packet counter), and modify one or more transmission parameters at a second time using a second refined CFO based on the comparison. These operations may be performed according to the methods described with reference to FIGS. 2 through 4. In certain examples, aspects of these operations may be performed by a CFO comparison component 640 as described with reference to FIGS. 5A through 6.

At block 1125, the device may modify a transmission parameter based at least in part on the refined CFO. In some examples, the STA 115 may modify one or more UL transmission parameters based on the refined CFO. In some examples, the AP 105 may modify one or more DL transmission parameters based on the refined CFO. The operations of block 1125 may be performed according to the methods described with reference to FIGS. 2 through 4. In certain examples, aspects of the operations of block 1125 may be performed by a modification component 555 or 635 as described with reference to FIGS. 5A through 6.

At block 1130, the device may transmit a signal in a MU-MIMO environment based at least in part on the modified transmission parameter. In some examples, the STA 115 may transmit an UL signal in an UL MU-MIMO environment based at least in part on one or more modified transmission parameters. In some examples, the AP 105 may transmit a DL data in a DL MU-MIMO environment based at least in part on one or more modified transmission parameters. The operations of block 1130 may be performed according to the methods described with reference to FIGS. 2 through 4. In certain examples, aspects of the operations of block 1130 may be performed by a transmitter 520 or 520-a as described with reference to FIGS. 5A through 6.

It should be noted that the methods discussed above describe possible implementations, and that the operations and the steps may be rearranged or otherwise modified and that other implementations are possible. Furthermore, aspects from two or more of the methods may be combined.

The wireless communications system or systems described herein may support synchronous or asynchronous operation. For synchronous operation, the access points may have similar frame timing, and transmissions from different access points may be approximately aligned in time. For asynchronous operation, the access points may have different frame timing, and transmissions from different access points may not be aligned in time. The techniques described herein may be used for either synchronous or asynchronous operations.

The DL transmissions described herein may also be called forward link transmissions while the UL transmissions may also be called reverse link transmissions. Each communication link described herein—including, for example, wireless communications systems such as WLAN 100 and wireless communications system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration). Thus, the functions described herein may be performed by one or more other processing units (or cores), on at least one IC. In various examples, different types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication in a multi-user multiple-input and multiple-output (MU-MIMO) environment, in a system comprising:
a processor;
memory in electronic communication with the processor; and
instructions stored in the memory and operable, when executed by the processor, to cause the apparatus to:
determine one or more unfiltered carrier frequency offsets (CFOs);
filter the one or more unfiltered CFOs to identify a refined CFO based at least in part on the one or more unfiltered CFOs and a predetermined number of packets;
modify a transmission parameter based at least in part on the refined CFO; and
transmit a signal in a MU-MIMO environment based at least in part on the modified transmission parameter.

2. The apparatus of claim 1, wherein the instructions are further executable by the processor to:
compare an unfiltered CFO with the refined CFO; and
set the refined CFO based at least in part on the comparison.

3. The apparatus of claim 1, wherein the instructions are further executable by the processor to:
determine whether to modify the transmission parameter based at least in part on comparing the refined CFO and an oscillator adjustment value.

4. The apparatus of claim 1, wherein the instructions to modify the transmission parameter further executable by the processor to:
precorrect a transmission timing, or a transmission frequency, or a combination thereof based at least in part on the refined CFO, wherein transmitting the signal in the MU-MIMO environment is based at least in part on the precorrection.

5. The apparatus of claim 1, wherein the instructions are further executable by the processor to:
compare an unfiltered CFO with the refined CFO; and
disregard the unfiltered CFO based at least in part on the comparison.

6. The apparatus of claim 1, wherein the instructions are further executable by the processor to:
compare the refined CFO relative to a threshold adjustment value, wherein the modified transmission parameter is based at least in part on the comparison, wherein the transmission parameter comprises a transmission frequency.

7. The apparatus of claim 1, wherein the instructions are further executable by the processor to:
determine a drift value associated with a clock source; and
determine whether to adjust the refined CFO based at least in part on the determined drift value and an elapsed time, wherein the modified transmission parameter is based at least in part on determining whether to adjust the refined CFO.

8. The apparatus of claim 1, wherein the instructions are further executable by the processor to:
compare an unfiltered CFO with the refined CFO;
adjust the unfiltered CFO based at least in part on the comparison; and
update the refined CFO based at least in part on the adjusted unfiltered CFO.

9. The apparatus of claim 1, wherein the instructions are further executable by the processor to:
determine the predetermined number of packets based at least in part on a clock source, wherein determining the refined CFO is based at least in part on the determined predetermined number of packets.

10. The apparatus of claim 1, wherein the instructions are further executable by the processor to:
determine whether a received transmission from the device is intended for a station or an access point, wherein determining one or more unfiltered CFOs is based at least in part on determining whether the received transmission from the device is intended for the station or the access point.

11. The apparatus of claim 1, wherein the instructions are further executable by the processor to:
compare an elapsed time between two received transmissions, wherein determining the refined CFO by filtering is based at least in part on a packet received after the elapsed time.

12. The apparatus of claim 1, wherein the instructions are further executable by the processor to:
identify a number of received transmissions from the device; and
compare the number of received transmissions to a packet threshold value, wherein the filtering is performed on a number of packets based at least in part on the comparison.

13. The apparatus of claim 1, wherein the filtering comprises:
using a moving average.

14. The apparatus of claim 1, wherein the instructions are further executable by the processor to:
determine one or more additional unfiltered CFOs;
filter the one or more additional unfiltered CFOs to identify a second refined CFO; and
compare the refined CFO and the second refined CFO, wherein the modified transmission parameter is based at least in part on the comparison.

15. The apparatus of claim 1, wherein the instructions to filter the one or more unfiltered CFOs to identify the refined CFO are further executable by the processor to:
filter the one or more unfiltered CFOs at a first time;
receive a transmission after the first time; and
filter a subset of the one or more unfiltered CFOs based at least in part on the received transmission.

16. The apparatus of claim 1, wherein the instructions are further executable by the processor to:
determine that a first modification of the transmission parameter based on the refined CFO occurred at a first time;
compare a number of received packets since the first time to a packet counter; and
modify the transmission parameter at a second time using a second refined CFO based at least in part on the comparison.

17. A method for wireless communication in a multi-user multiple-input and multiple-output (MU-MIMO) environment, comprising:
determining one or more unfiltered carrier frequency offsets (CFOs);
filtering the one or more unfiltered CFOs to identify a refined CFO based at least in part on the one or more unfiltered CFOs and a predetermined number of packets;
modifying a transmission parameter based at least in part on the refined CFO; and
transmitting a signal in a MU-MIMO environment based at least in part on the modified transmission parameter.

18. The method of claim 17, further comprising:
comparing an unfiltered CFO with the refined CFO; and
setting the refined CFO based at least in part on the comparison.

19. The method of claim 17, further comprising:
determining whether to modify the transmission parameter based at least in part on comparing the refined CFO and an oscillator adjustment value.

20. The method of claim 17, further comprising:
comparing an unfiltered CFO with the refined CFO;
adjusting the unfiltered CFO based at least in part on the comparison; and
updating the refined CFO based at least in part on the adjusted unfiltered CFO.

21. The method of claim 17, further comprising:
comparing an elapsed time between two received transmissions, wherein determining the refined CFO by filtering is based at least in part on a packet received after the elapsed time.

22. The method of claim 17, further comprising:
determining one or more additional unfiltered CFOs;
filtering the one or more additional unfiltered CFOs to identify a second refined CFO; and
comparing the refined CFO and the second refined CFO, wherein the modified transmission parameter is based at least in part on the comparison.

23. The method of claim 17, wherein filtering the one or more unfiltered CFOs to identify the refined CFO comprises:
filtering the one or more unfiltered CFOs at a first time;
receiving a transmission after the first time; and
filtering a subset of the one or more unfiltered CFOs based at least in part on the received transmission.

24. The method of claim 17, further comprising:
determining that a first modification of the transmission parameter based on the refined CFO occurred at a first time;
comparing a number of received packets since the first time to a packet counter; and
modifying the transmission parameter at a second time using a second refined CFO based at least in part on the comparison.

25. An apparatus for wireless communication in a multi-user multiple-input and multiple-output (MU-MIMO) environment, comprising:
a carrier frequency offset (CFO) component for determining one or more unfiltered CFOs;
a CFO filter component for filtering the one or more unfiltered CFOs to identify a refined CFO based at least in part on the one or more unfiltered CFOs and a predetermined number of packets;
a modification component for modifying a transmission parameter based at least in part on the refined CFO; and
a transmitter component for transmitting a signal in a MU-MIMO environment based at least in part on the modified transmission parameter.

26. The apparatus of claim 25, further comprising:
a CFO component for determining one or more additional unfiltered CFOs; and
a CFO filtering component for filtering the one or more additional unfiltered CFOs to identify a second refined CFO;
a CFO comparison component for comparing the refined CFO and the second refined CFO, wherein the modified transmission parameter is based at least in part on the comparison.

27. The apparatus of claim 25, wherein:
the CFO filter component is configured for filtering the one or more unfiltered CFOs at a first time,
a receiver component is configured for receiving a transmission after the first time, and
the CFO filter component is configured for filtering a subset of the one or more unfiltered CFOs based at least in part on the received transmission.

28. A non-transitory computer readable medium storing code for wireless communication in a multi-user multiple-input and multiple-output (MU-MIMO) environment, the code comprising instructions executable by a processor to:
determine one or more unfiltered carrier frequency offsets (CFOs);
filter the one or more unfiltered CFOs to identify a refined CFO based at least in part on the one or more unfiltered CFOs and a predetermined number of packets;
modify a transmission parameter based at least in part on the refined CFO; and
transmit a signal in a MU-MIMO environment based at least in part on the modified transmission parameter.

29. The non-transitory computer readable medium of claim 28, wherein the instructions are further executable by the processor to:
determine one or more additional unfiltered CFOs;
filter the one or more additional unfiltered CFOs to identify a second refined CFO; and
compare the refined CFO and the second refined CFO, wherein the modified transmission parameter is based at least in part on the comparison.

30. The non-transitory computer readable medium of claim 28, wherein the instructions are further executable by the processor to:
filter the one or more unfiltered CFOs at a first time;
receive a transmission after the first time; and
filter a subset of the one or more unfiltered CFOs based at least in part on the received transmission.
